(19) United States
(12) Patent Application Publication
(10) Pub. No.: US 2024/0305384 A1
(43) Pub. Date: Sep. 12, 2024

(54) RECEIVER SYSTEM AND METHOD OF OPERATING A RECEIVER SYSTEM

(71) Applicant: SIGNIFY HOLDING B.V., EINDHOVEN (NL)

(72) Inventors: ANDRIES VAN WAGENINGEN, WIJLRE (NL); PAUL HENRICUS JOHANNES MARIA VAN VOORTHUISEN, SINT OEDENRODE (NL)

(21) Appl. No.: 18/278,587

(22) PCT Filed: Feb. 17, 2022
(86) PCT No.: PCT/EP2022/053952

§ 371 Date: Aug. 23, 2023

(30) Foreign Application Priority Data
Mar. 4, 2021 (EP) 21160703.1

(51) Int. Cl. H04B 10/69; H04B 10/116

(52) U.S. Cl. CPC H04B 10/691; H04B 10/116

(57) ABSTRACT

A receiver system (300) comprises: a modem (320) having at least two input interfaces (321a, 321b): a front-end (310); and a selection unit (314). The front-endcomprises a plurality of photodetectors (311) for receiving optical wireless communication. OWC, signals, and a switch arrangement (313) for selectively passing OWC signals to the input interfaces (321a, 321b) of the modem. The modem configured to assign, for each input interface, a respective recommendation, for use by the selection unit. The selection unit configured to select OWC signals to be passed by the switch arrangement to the modem based at least in part on the recommendations, one of the possible recommendations being a “de-selectable” recommendation for an OWC signal that can be deselected without jeopardizing an existing OWC connection and when a de-selectable recommendation is received, the selection unit configured to deselect the OWC signal and suggest an alternative based on incoming signal strengths.

### TECHNICAL FIELD

The present disclosure relates to a receiver system and a method of operating a receiver system in an optical wireless communication network.

### BACKGROUND

Optical Wireless Communication (OWC) refers to techniques whereby information is communicated in the form of a signal embedded in light (including for example visible light, or infrared light) emitted by a light source. Depending for example on the particular wavelengths used, such techniques may also be referred to as coded light, Light Fidelity (LiFi), visible light communication (VLC) or free-space optical communication (FSO). These terms are often used interchangeably. In this context: visible light may be light that has a wavelength in the range 380 nm to 740 nm; and infrared light may be light that has a wavelength in the range 740 nm to 1.5 mm. It is appreciated that there may be some overlap between these ranges.

### SUMMARY

According to a first aspect disclosed herein, there is provided a receiver system for receiving optical wireless communication, OWC, signals from an access point device of an OWC network, the receiver system comprising: a modem having at least a first input interface and a second input interface; a front end comprising: a plurality of photodetectors for receiving optical wireless communication, OWC, signals; and a switch arrangement for selectively passing electrical OWC signals from the photodetectors to the modem via the input interfaces; and a selection unit for controlling the switch arrangement; wherein: the modem is configured to assign, for each input interface, a respective recommendation, for use by the selection unit, to electrical OWC signals currently being passed by the switch arrangement to the modem via that input interface, and provide said recommendations to the selection unit; the selection unit is configured to select electrical OWC signals to be passed by the switch arrangement to the input interfaces of the modem based at least in part on the recommendations received from the modem, and to control the switch arrangement in accordance with the selected electrical OWC signals wherein the modem is configured to assign a de-selectable recommendation to an OWC signal that can be deselected without jeopardizing an existing OWC connection and when said recommendations includes the de-selectable recommendation for an OWC signal, the selection unit is configured to deselect the OWC signal having the de-selectable recommendation from being passed by the switch arrangement to the input interfaces of the modem and selectively pass another, not currently being passed, electrical OWC signal from the photodetectors to the modem via the input interfaces, based on received signal strengths. The first aspect provides a switch arrangement that may assist the modem in a loosely controlled manner, whereby an interface is defined between the modem and the switch arrangement using a limited number of (control) pins, that allows for local decision making by the switching arrangement, under guidance from the modem. In this manner a balance is struck that provides a simple control interface for a potentially a large number of photodetectors.

The interfaces may be pins of the modem.

The selection unit may be implemented in the front end, in the modem, or as a separate entity.

The photodetectors preferably are arranged for providing angular and/or spatial receiver diversity.

The receiver system may be implemented at any receiving device. Examples include an end point and an access point of an OWC network. An access point may have multiple front ends each operatively coupled to the modem.

Said recommendations include at least a de-selectable recommendation, and the selection unit is configured to deselect (or, in examples, be able to deselect) any OWC signals having the de-selectable recommendation from being passed by the switch arrangement to the input interfaces of the modem. In this manner the selection unit is handed over partial control and is enabled to suggest alternatives based on incoming signal strengths. The selection unit is informed of which OWC signals are not “important” to the modem for OWC network connection (at that point in time). This means that the selection unit “knows” which OWC signal(s) it can deselect without jeopardising the OWC network connection.

In an example, said recommendations include at least a keep recommendation, and the selection unit is configured not deselect (or, in examples, not be able to deselect) any OWC signal having the keep recommendation from being passed by the switch arrangement to the input interfaces of the modem.

In an example, the modem is configured to assign the keep category to one or more OWC signals that the modem is currently using to connect to an OWC network. In this manner, a situation can be avoided in which the selection unit would have otherwise deselected a particular OWC signal which is currently critical to the maintaining the OWC network connection.

In an example, the modem is configured to assign the de-selectable recommendation to an OWC signal that the modem is not currently using to connect to an OWC network.

In an example, said recommendations include at least a preferably-keep recommendation, the selection unit being configured so as to only deselect an OWC signal having the preferably-keep recommendation if a signal strength of that OWC signal falls below a threshold signal strength. In this manner the selection unit is provided with guidance as regards alternatives to suggest.

In an example, said categories include at least a discard recommendation, and the selection unit of the front end is configured to not select an OWC signal having the discard recommendation. In this manner interference from non-contributing signals may be reduced.

In an example, the recommendations are associated with a numerical value, and the selection unit is configured to select OWC signals to be passed by the switch arrangement based on one of maximising and minimising the sum of the numerical recommendations assigned by the modem. In this manner, an optimum selection of OWC signals by the selection unit can be made, based on knowledge provided by the modem. That is, the modem is able to assign numerical values to the OWC signals, with the expectation that the selection unit will seek a maximum/minimum sum of these values. E.g, assigning a zero value to an OWC signal may be equivalent to indicating to the selection unit that that particular OWC signal is neither beneficial nor detrimental to the OWC network connection. The assigned numerical values may be natural numbers (with or without zero), integers (i.e. including negative whole numbers and zero), or rational numbers.

In an example, the front end comprises at least one signal strength detector for measuring signal strengths of OWC signals received via the photodetectors and providing the measured strengths to the selection unit, and wherein the selection unit is configured to select OWC signals to be passed by the switch arrangement based on the measured signal strengths and subject to the assigned recommendations.

In an example, the modem is configured to demodulate the OWC signals received via each input interface and to assign said recommendations based on at least one property of the demodulated signals selected from: a signal to noise ratio, a bit-error rate, a sub-channel dependency, a signal to interference ratio (SIR), and a signal to noise and interference ratio (SNIR). Assigning categories based on these properties, in particular SIR and SNIR, can help address the interference of a neighbour AP (when the modem is implemented at an EP) or help address interference of a non-registered EP (when the modem is implemented at an AP).

In an example, the selection unit is configured to search for a new OWC signal if none of the currently selected OWC signals is assigned a recommendation by the modem that indicates that the OWC signal is not to be deselected or is preferably to be kept, and to provide an indication of the new OWC signal to the modem, the modem being configured to analyse the new OWC signal next on receipt of the indication.

In an example, the selection unit is configured to perform a new selection of which OWC signals to pass to the modem in response to an instruction received from the modem. The modem may, for example, indicate a specific point in time or a time schedule. The instruction mechanism may be used by the modem to indicate that it has finalized its evaluation and a new selection is requested. Alternatively, it may be used in situations where it is not clear who may access the channel. For example, in case of a Time Division Multiplexed Access scheme during discovery periods, or in case of a Carrier Sense Multiple Access scheme to enable end points to contend for channel access. The same mechanism may also be used to facilitate link acquisition in case an on-going link is broken.

In an example, the switch arrangement may pass multiple OWC signals to a single pin of the modem. The switch arrangement may attenuate or amplify one or more of these OWC signals. Alternatively, or additionally, separate attenuators and/or amplifiers may be provided (e.g. one per pin of the modem).

In an example, there may be a pre-selection unit which first removes any OWC signals having a signal quality metric lower than a predetermined threshold, before passing the remaining OWC signals to the selection unit for use as described herein. Examples of such signal quality metrics include a signal to noise ratio, a bit-error rate, a sub-channel dependency, a signal to interference ratio (SIR), and a signal to noise and interference ratio (SNIR).

According to a second aspect disclosed herein, there is provided a front end for use in a receiver system, the front end comprising: a plurality of photodetectors for receiving optical wireless communication, OWC, signals; a switch arrangement for selectively passing OWC signals from the photodetectors to a modem that comprises at least two input interfaces over which the OWC signals are passed in use by the switch arrangement; and a selection unit for controlling the switch arrangement; wherein: the selection unit is arranged so as to be able to receive from the modem, when the front end is connected to the modem, a respective recommendation for OWC signals currently being passed by the switch arrangement to each input interface of the modem; the selection unit is configured to select OWC signals to be passed by the switch arrangement to the input interfaces of the modem based at least in part on the recommendations received from the modem, and to control the switch arrangement in accordance with the selected OWC signals; and when said recommendations includes a de-selectable recommendation for an OWC signal, the selection unit is configured to deselect the OWC signals having the de-selectable recommendation from being passed by the switch arrangement to the input interfaces of the modem and selectively pass another, not currently being passed, electrical OWC signal from the photodetectors to the modem via the input interfaces, based on received signal strengths.

According to a third aspect disclosed herein, there is provided a modem for receiving optical wireless communication, OWC, signals from an access point of an OWC network, the modem comprising: a first input interface and a second input interface for receiving OWC signals passed by a switch arrangement of a front end that comprises a plurality of photodetectors for receiving OWC signals; wherein the modem is configured to assign, for each input interface, a respective recommendation to OWC signals currently being passed by the switch arrangement to the modem via that input interface when the front end is connected to the modem, and to provide said recommendations to a selection unit for use by the selection unit in selecting OWC signals to be passed by the switch arrangement to the input interfaces of the modem; wherein the modem (320) is configured to assign a de-selectable recommendation to an OWC signal that can be deselected without jeopardizing an existing OWC connection.

According to a fourth aspect disclosed herein, there is provided a method of communicating with a modem of a receiver system, the modem having at least two input interfaces, the method comprising: controlling a switch arrangement to selectively pass optical wireless communication, OWC, signals from a plurality of photodetectors to the modem; receiving, from the modem, a respective recommendation for OWC signals currently being passed to each input interface of the modem; and selecting OWC signals to be passed by the switch arrangement to the input interfaces of the modem based at least in part on the recommendations received from the modem; and controlling the switch arrangement in accordance with the selected OWC signals, by deselecting an OWC signals having a de-selectable recommendation from being passed by the switch arrangement to the input interfaces of the modem when said recommendations includes the de-selectable recommendation for the OWC signal; and selectively passing, another, not currently being passed, electrical OWC signal from the photodetectors to the modem via the input interfaces, based on received signal strengths.

According to a fifth aspect disclosed herein, there is provided a method of communicating with a front-end of a receiver system, the method comprising: receiving, via a first input interface and a second input interface of a modem, optical wireless communication, OWC, signals passed by a switch arrangement of the front end that comprises a plurality of photodetectors for receiving OWC signals; assigning, for each input interface, a respective recommendation to OWC signals currently being received via that input interface; providing said recommendations to a selection unit for use by the selection unit in selecting OWC signals to be passed by the switch arrangement to the input interfaces of the modem; and wherein the modem assigns a de-selectable recommendation to an OWC signal that can be deselected without jeopardizing an existing OWC connection.

In an example, the receiver system comprises a plurality of front ends, each having at least one of said plurality of photodetectors.

In an example, at least one of the plurality of front ends comprises a plurality of photodetectors arranged in a plurality of sectors.

In an example, at least one of the plurality of front ends comprises:
a plurality of photodetectors arranged in a plurality of sectors;
a front end switch arrangement for selectively passing electrical OWC signals from the plurality of photodetectors to the switch arrangement; and
a front end selection unit configured to control the front end switch arrangement.

In an example, said recommendations include at least a keep recommendation, and the selection unit is configured so to deselect (or, in example, to not be able to deselect) any OWC signal having the keep recommendation from being passed by the switch arrangement to the input interfaces of the modem. In this manner, a situation can be avoided in which the selection unit would have otherwise deselected a particular OWC signal which is currently critical to the maintaining the OWC network connection.

In an example, the modem is configured to assign the keep recommendation to one or more OWC signals that the modem is currently using to connect to an OWC network. In an example, said recommendations include at least a de-selectable recommendation, and the selection unit is configured to deselect (or, in examples, to be able to deselect) any OWC signals having the de-selectable recommendation from being passed by the switch arrangement to the input interfaces of the modem. In this manner the selection unit is handed over partial control and is enabled to suggest alternatives based on incoming signal strengths. The selection unit is informed of which OWC signals are not “important” to the modem for OWC network connection (at that point in time). This means that the selection unit “knows” which OWC signal(s) it can deselect without jeopardising the OWC network connection.

In an example, the modem is configured to assign the de-selectable recommendation to an OWC signal that the modem is not currently using to connect to an OWC network.

In an example, said recommendations include at least a select all recommendation, and the selection unit is configured to deselect (or, in examples, not to be able to deselect) any OWC signal if the select all recommendation is assigned by the modem.

In an example, the receiver system is configured to communicate with the endpoint devices according to a TDMA schedule, wherein the modem is configured to assign recommendations based on the TDMA schedule. That is, each time slot within the TDMA schedule may be treated independently by the modem. For example, the modem may assign categories to each of the OWC signals (in any manner described herein) for each of the time slots separately. E.g. a given OWC signal may have a first category in relation to a first time slot, but a second category in relation to a second time slot. This allows for different requirements of each of the endpoint devices to be taken into account.

In an example, the modem is configured to apply a mode-identifier corresponding to each endpoint device, and the selection unit is configured to apply a different mode of operation for each mode-identifier. That is, each endpoint device may be identified by a different mode identifier, and the modem may use these mode identifiers to assign categories on a per-endpoint device (per-mode identifier) basis. This allows for different requirements of each of the endpoint devices to be taken into account.

In an example, the recommendations are associated with a numerical value, and the selection unit is configured to select OWC signals to be passed by the switch arrangement based on one of maximising and minimising the sum of the numerical recommendations assigned by the modem. In this manner, an optimum selection of OWC signals by the selection unit can be made, based on knowledge provided by the modem. That is, the modem is able to assign numerical values to the OWC signals, with the expectation that the selection unit will seek a maximum/minimum sum of these values. E.g. assigning a zero value to an OWC signal may be equivalent to indicating to the selection unit that that particular OWC signal is neither beneficial nor detrimental to the OWC network connection. The assigned numerical values may be natural numbers (with or without zero), integers (i.e. including negative whole numbers and zero), or rational numbers.

In an example, the front end comprises at least one signal strength detector for measuring signal strengths of OWC signals received via the photodetectors and providing the measured strengths to the selection unit, and wherein the selection unit is configured to select OWC signals to be passed by the switch arrangement based on the measured signal strengths and subject to the assigned recommendations.

In an example, the modem is configured to demodulate the OWC signals received via each input interface and to assign said recommendations based on at least one property of the demodulated signals selected from: a signal to noise ratio, a bit-error rate, a sub-channel dependency, a signal to interference ratio (SIR), and a signal to noise and interference ratio (SNIR). Assigning categories based on these properties, in particular SIR and SNIR, can help address the interference of a neighbour AP (when the modem is implemented at an EP) or help address interference of a non-registered EP (when the modem is implemented at an AP).

In an example, the selection unit is configured to perform a new selection of which OWC signals to pass to the modem in response to an instruction received from the modem.

According to a ninth aspect disclosed herein, there is provided a modem for use in a receiver system for receiving optical wireless communication, OWC, signals from endpoint devices of an OWC network, the modem comprising:
a first input interface and a second input interface for receiving OWC signals passed by a switch arrangement from a plurality of photodetectors arranged in respective sectors for receiving OWC signals;
wherein the modem is configured to assign, for each input interface, a respective recommendation to OWC signals currently being passed by the switch arrangement to the modem via that input interface when the front end is connected to the modem, and to provide said recommendations to a selection unit for use by the selection unit in selecting OWC signals to be passed by the switch arrangement to the input interfaces of the modem;
wherein the modem is configured to assign respective recommendations for each endpoint device from which it receives OWC signals.

According to a tenth aspect disclosed herein, there is provided a method of communicating with a modem of a receiver system, the modem having at least two input interfaces, the method comprising:
controlling a switch arrangement to selectively pass optical wireless communication, OWC, signals from a plurality of photodetectors to the modem;
receiving, from the modem, a respective recommendation for OWC signals currently being passed to each input interface of the modem; and
selecting OWC signals to be passed by the switch arrangement to the input interfaces of the modem based at least in part on the recommendations received from the modem; and controlling the switch arrangement in accordance with the selected OWC signals;
wherein respective recommendations are assigned for each endpoint device from which it receives OWC signals.

According to an eleventh aspect disclosed herein, there is provided a method of communicating with a front end of a receiver system for receiving optical wireless communication, OWC, signals from endpoint devices of an OWC network, the method comprising:
receiving, via a first input interface and a second input interface of a modem, OWC signals passed by a switch arrangement from a plurality of photodetectors arranged in a plurality of sectors for receiving OWC signals;
assigning, for each input interface, a respective recommendation to OWC signals currently being received via that input interface; and
providing said recommendations to a selection unit for use by the selection unit in selecting OWC signals to be passed by the switch arrangement to the input interfaces of the modem;
wherein respective recommendations are assigned for each endpoint device from which it receives OWC signals.

According to a twelfth aspect disclosed herein, there is provided a computer program comprising instructions such that when the computer program is executed on a computing device, the computing device is arranged to implement a method of communicating with a modem of a receiver system, the modem having at least two input interfaces, the method comprising:
controlling a switch arrangement to selectively pass optical wireless communication, OWC, signals from a plurality of photodetectors to the modem;
receiving, from the modem, a respective recommendation for OWC signals currently being passed to each input interface of the modem; and
selecting OWC signals to be passed by the switch arrangement to the input interfaces of the modem based at least in part on the recommendations received from the modem; and controlling the switch arrangement in accordance with the selected OWC signals;
wherein respective recommendations are assigned for each endpoint device from which it receives OWC signals.

According to a thirteenth aspect disclosed herein, there is provided a computer program comprising instructions such that when the computer program is executed on a computing device, the computing device is arranged to implement a method comprising:
receiving, via a first input interface and a second input interface of a modem, optical wireless communication, OWC, signals passed by a switch arrangement from a plurality of photodetectors arranged in a plurality of sectors for receiving OWC signals;
assigning, for each input interface, a respective recommendation to OWC signals currently being received via that input interface; and
providing said recommendations to a selection unit for use by the selection unit in selecting OWC signals to be passed by the switch arrangement to the input interfaces of the modem;
wherein respective recommendations are assigned for each endpoint device from which it receives OWC signals.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an EP located at a first location within an OWC network;

FIG. 2 shows schematically an EP located at a second location within an OWC network;

FIG. 3 shows schematically an EP located at a third location within an OWC network;

FIG. 4 shows schematically an EP located at a fourth location within an OWC network; and

FIG. 5 shows schematically a receiver system in accordance with a first example described herein;

FIG. 6 shows schematically a receiver system in accordance with a second example described herein;

FIG. 7 shows schematically a receiver system in accordance with a third example described herein;

FIG. 8 shows schematically a receiver system in accordance with a fourth example described herein;

FIG. 9 shows schematically a receiver system in accordance with a fifth example described herein;

FIG. 10 shows an example method in accordance with examples described herein; and

FIG. 11 shows schematically a receiver system in accordance with a sixth example described herein.

### DETAILED DESCRIPTION

OWC/LiFi/VLC/FSO signals can be received using photodetectors which generate an electrical signal in response to incident light. The photodetectors act as transducers for converting optical OWC signals to electrical OWC signals. For simplicity, the term “OWC signal” or similar may sometimes be used to refer to both the optical OWC signals (modulated light) and the generated electrical OWC signals (carrying the same information). A “sectorised” or “segmented” OWC receiver is a device which comprises a plurality of “sectors” or “segments”, each segment having a photodetector for receiving OWC signals from a transmit device over a particular reception angle or volume.

Examples disclosed herein relate to a receiver system for use in an optical wireless communication, OWC, network and a method of operating a receiver system. The receiver system may be part of an endpoint device (EP), which in use communicates with an access point (AP) of the OWC network. Conversely the receiver system may be part of the AP which in use may communicate to one or more EPs. An EP is typically a user device or user equipment. In examples, the EP may be a dedicated entity connected to or incorporated in a laptop computer or other end device. In other examples, the EP may be partially or fully integrated to a device such as a smart phone, a tablet, a computer, a remote controller, a smart TV, a display device, a storage device, a home appliance, or another smart electronic device.

The receiver system comprises a modem and an optical front end (or simply “front end”). The front end has a plurality of photodetectors for receiving OWC signals, typically arranged to receive OWC signals over a plurality of sectors, that is, over a particular reception angle or volume. Such sectors may be discrete sectors or some or all of the sectors may overlap with another sector.

In use, the front end passes received OWC signals to the modem, and the modem demodulates the OWC signals for output to another device (e.g. a processor). The front end may receive a different OWC signal from each sector, or receive the same OWC signal with a different signal quality. For this reason, one task for the receiver system is to select which sector or sectors to use to establish and/or maintain a good connection to the (rest of the) OWC network.

Because demodulation of the OWC signals is performed by the modem, only the modem (and not the front end) is able to analyse signal quality metrics pertaining to the actual data embedded in the OWC signals, e.g. in the baseband. The front end, only having access to the received OWC signals prior to demodulation, is limited to analysing coarse signal quality metrics (e.g. signal strength). Hence, implementing the decision entirely at the front end removes the possibility of taking richer quality metrics into account.

The modem, on the other hand, may indeed be able to analyse a richer set of signal quality metrics (e.g. packet loss, data rate, etc). However, given the potentially high number of OWC signals that need to be selected from, implementing the decision of which sectors and therefore OWC signals to use entirely at the modem can drastically increase both processing power and time requirements.

Examples disclosed herein relate to a “smart interface” which allows both the front end and the modem to play a part in the decision of which sector/OWC signal to use. A simple and coarse pre-selection is enacted in the front end and advanced selection on the pre-selected signals is performed based on analysis of received (and optionally demodulated) OWC signals by the modem.

In use, the front end selectively passes OWC signals from the photodetectors to the modem under control of a selection unit. The selection unit may or may not be implemented as part of the front end itself. There may be more OWC signals (from different respective sectors) that need to or can be passed to or processed by the modem, so the selection unit typically controls the front end to selectively pass only some but not all of the OWC signals from the photodetectors to the modem. The modem assigns recommendations/categories to the pre-selected OWC signals. The term “category” is used herein generally to refer to any kind of recommendation, which may otherwise be called, for example, priorities, preferences, guidance indications, ranks, scores, classes, or levels or similar. The modem provides the assigned categories to the selection unit. Put simply, the categories indicate to the selection unit the usefulness of each OWC signal to the modem. The selection unit then uses the categories to make a more informed decision as to which OWC signals to pass from the front end to the modem. For example, the modem may assign a “keep” category to one OWC signal (e.g. if that OWC signal is currently being used by the modem to connect to the OWC network), in which case the selection unit will continue to pass that OWC signal to the modem. As another example, the modem may assign a “de-selectable” category to an OWC signal (e.g. if the modem is not currently using that OWC signal to connect to the OWC network), in which case the selection unit knows that it can swap that OWC signal out for another OWC signal to be passed to the modem.

Instead of recommending the modem may also enforce the selection unit to take a certain action, e.g. The modem may indicate that the selection unit shall keep or remove an OWC signal. The feedback of the modem on the selection/de-selection of a signal can also be part of a control cycle. For example, the selection unit starts a control cycle by selecting a new signal and indicating so to the modem and keeps this signal selected until later notice. The modem responds with an accept/reject after analysing the signal to which the selection unit takes the corresponding action of keeping/de-selecting the signal respectively.

Advantages include limiting the required processing power in both the front end and the modem, and limiting the number of OWC signals being passed from the front end to the modem. In particular, the categories represent information regarding the requirements of the modem, which allows the selection unit to select an optimal set of OWC signals to pass to the modem (which may, and typically will, change over time as environmental conditions change, as an end user device moves, etc.). The modem needs then only to process this smaller set of OWC signals in order to select which one to use for connecting to and/or maintaining a connection with the OWC network generally and/or a transmitter device, saving both time and processing power requirements at the modem and/or the front end. In effect, the front end and the modem can cooperate to make a decision as to which OWC signal(s)/sector(s) to use.

The communication between the front end and the modem may be implemented using any suitable connection, e.g. a serial bus (SPI, UART, I2C, etc.) Where a unidirectional communication may work well to indicate a recommendation from modem to selection unit on a currently selected signal, in some examples, as described later below, the communication may preferably be a bi-directional communication. Bi-directional communication allows for more advanced cooperation between selection unit and modem. For example, the selection unit may communicate a signal identifier for the currently selected signal, which enables the modem to indicate a recommendation or to respond on in a control cycle at a time when the signal is not selected by using the signal identifier. As another example, the front end may then indicate a new signal on a particular input interface (pin) of the modem such that the modem is able to start the assessment of this new signal first, potentially saving time.

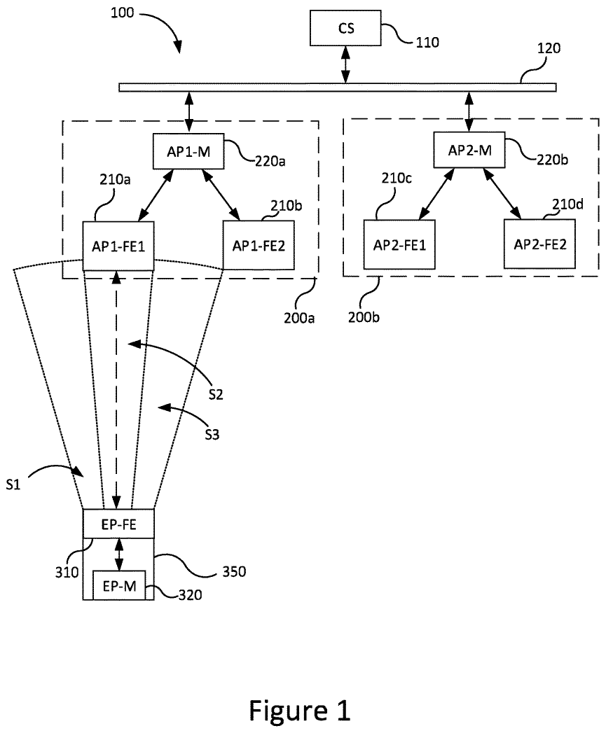

FIG. 1 shows schematically an example of an OWC network system 100 (also referred to herein as OWC network 100).

The OWC network 100 comprises a control system 110, a backbone 120, and a plurality of access points (APs) 200. Typically, the control system 110, backbone 120, and APs 200 are “fixed” (do not move or change, at least over short time scales). For example, the APs 200 may be installed in a ceiling of a room. It is appreciated that the OWC network 100 shown schematically in FIG. 1 is simplified for the purposes of explanation and that the OWC network 100 may, for example, comprise further access points, as well as additional elements such as, for example, an IP router, ethernet switch, etc. The OWC network 100 may also be connected to an external network, also not shown in FIG. 1, such as a wired and/or wireless local area network and/or the Internet.

Each AP 200 comprises a modem 220 and at least one optical front end 210 (also simply referred to herein as “front end”) for transmitting and receiving OWC signals. The modem 220 of each AP 200 is operatively coupled to all front ends 210 of that AP 200. The modem 220 and the, or each, front end 210 of an AP 200 are at least logically associated with each other but may be physically separate devices or formed as part of a single device. In case of the AP 200, there might be a multiplexer for selecting which signals are being received from which front end 210.

In this example, for the purposes of explanation only, the OWC network 100 comprises a first AP 200a having a first modem 220a, a first front end 210a and a second front end 210b, and a second AP 200b having a second modem 220b and a third front end 210c and a fourth front end 210d. It is appreciated that there may be more or fewer APs 200 present, and that each AP 200 may comprise more or fewer front ends 210. In general, each AP 200 may comprise the same or a different number of front ends 210.

The APs 200 and control system 110 are operatively coupled via the backbone 120. The backbone 120 provides a stable and high-speed communication link, which can be a wired connection, such as Ethernet, and/or a wireless connection based on for example radio frequency (RF) or millimetre-wave. The backbone 120 can also be or include another kind of optical wireless link that is different from the one that an end point is using in the optical multi-cell wireless network. One example of another kind of optical wireless link can be free space point-to-point optical links.

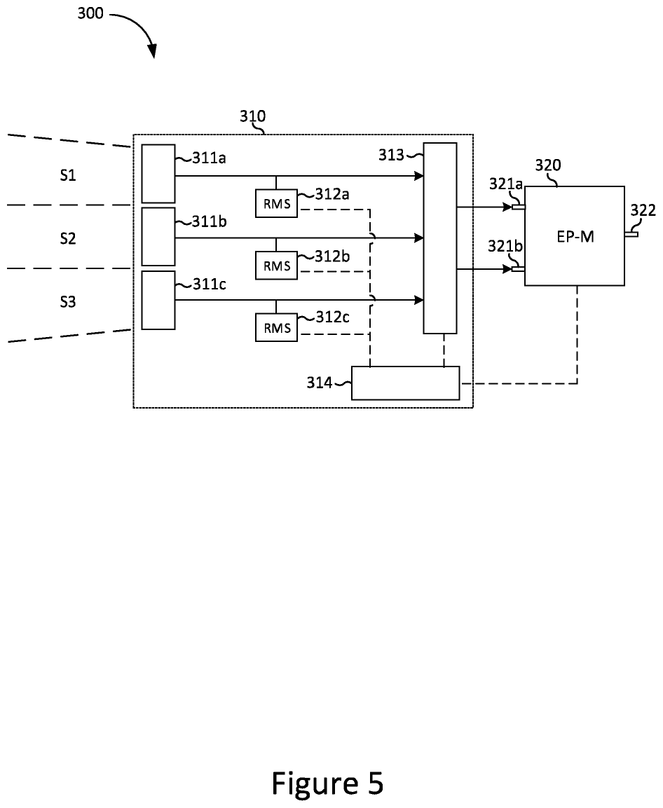

Also shown in FIG. 1 is an endpoint device (EP) 350. The EP 350 comprises its own front end 310 and modem 320. The front end 310 is a “sectorised” or “segmented” front end in that is has a plurality of photodetectors arranged to receive OWC signals over a plurality of different “sectors” or “segments” (discussed in more detail later in relation to FIG. 5). Specifically, the photodetectors are arranged into groups of one or more photodetector, each group being arranged to receive OWC signals over a different sector. The sectors are defined as the fields of view of the photodetector groups. However, for convenience and by convention, the term “sector” may also be used to refer to the group of photodetectors. In this example, there are three sectors: S1, S2, S3. However, it is appreciated there may be, in other examples, two sectors, four sectors, or five or more sectors. The sectors S1, S2, S3, . . . may be discrete sectors with no overlap or some or all of the sectors may overlap with another sector.

In examples, one or more of the front ends 210 of the APs 220 may be a “sectorised” or “segmented” front end. It will therefore be appreciated that the features of the sectors discussed in relation to sectors of an EP front end 310 apply equally in relation to sectors of an AP front end 210.

In the figures, the sectors S1, S2, S3 of the EP 350 are illustrated as sectors of a circle. It is appreciated that in the real world, the field of view of each sector will generally be a three-dimensional volume, the shape of which will depend on various factors including, for example, the layout of the environment in which the EP 350 is located, the physical shape and construction of the EP 350 itself, the orientation of the EP 350 within the environment, etc.

In operation, at any one point in time, the EP 350 is selectively associated to and synchronized with a respective one of the APs 210. That is, the EP 350 is registered with a respective one of the APs 210. This is illustrated in FIG. 1 using a dashed arrow indicating that the EP 350 is associated with the first AP 200a via the first front end 210a of the first AP 200a. Specifically, the first front end 210a of the first AP 200a is located within sector S2. Hence, the EP 350 uses sector S2 to receive OWC signals from the first front end 210a of the first AP 200a.

Unlike the control system 110, backbone 120, and APs 200, the EP 350 is typically not fixed. That is, the EP 350 may move around within the environment, changing position and/or orientation relative to APs 200, over potentially short time scales (of the order of seconds or less). In order to maintain a connection to the OWC network 100, a change of its position towards the AP front ends 210 should be supported. The best selection of the sector or sectors to use may therefore change if the EP 350 is moving. FIGS. 1, 2, 3, and 4 show the EP 350 located at different locations relative to the OWC network 100.

In FIG. 1, the EP 350 is positioned such that the first front end 210a of the first AP 200a is located within the second sector S2 of the EP 350. No APs 200 are present within the first sector S1 or the third sector S3 of the EP 350. This means that:
the (photodiodes of the) first sector S1 will not receive OWC signals (or will receive a relatively weak signal due to, for example, weak sidebands, noise, etc.). That is, no OWC signals (or only relatively weak signals) will be received over the first sensor S1;
the second sector S2 will receive (relatively strong) OWC signals output by the first front end 210a of the first AP 200a; and
the third sector S3 will not receive OWC signals (or will receive a relatively weak signal).

In this case, the EP 350 selects sector S2 for optimal connection to the first AP 200a via the first front end 210a.

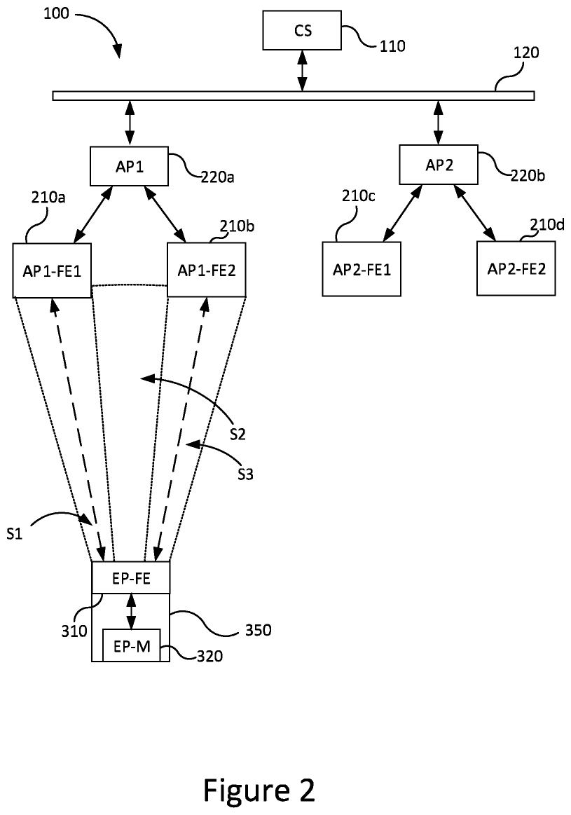

In FIG. 2, the EP 350 is positioned such that the first front end 210a of the first AP 200a is located within the first sector S1 and the second front end 210b of the first AP 200a is located within the third sector S3. No devices are present within the second sector S2. This means that:
the first sector S1 will receive (relatively strong) OWC signals output by the first front end 210a of the first AP 200a;
the second sector S2 will not receive OWC signals (or will receive a relatively weak signal); and
the third sector S3 will receive (relatively strong) OWC signals output by the second front end 210b of the first AP 200a.

In this case, the EP 350 may use either of the first front end 210a or the second front end 210b to connect to the OWC network. This is because both front ends 210a, 210b are associated with the same modem 220a. If the first AP 200a and the EP 350 support Multiple-Input Multiple-Output (MIMO) communication, the EP 350 may connect to the first AP 200a using both the first front end 210a and the second front end 210b, as shown schematically in FIG. 2.

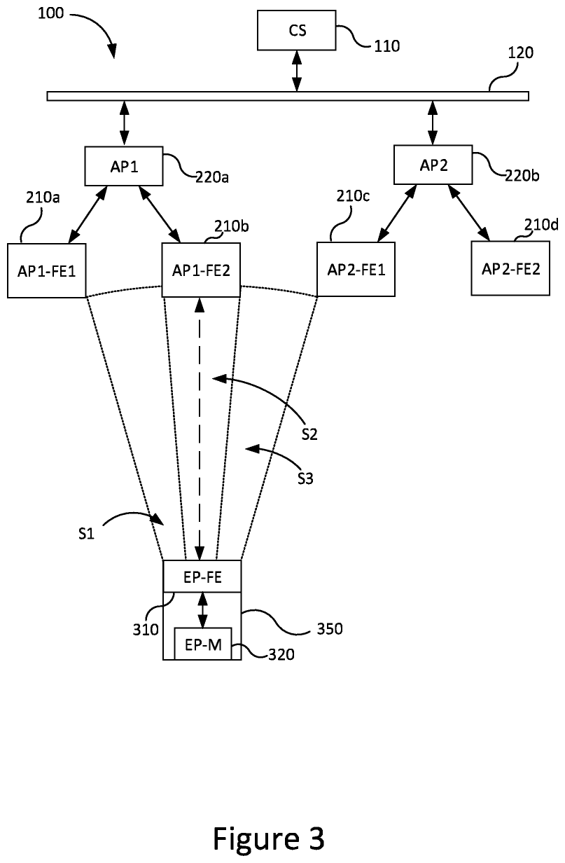

In FIG. 3, the EP 350 is positioned such that the second front end 210b of the first AP 200a is located within the second sector S2. No devices are present within the first sector S1 or the third sector S2. This means that:
the first sector S1 will not receive OWC signals (or will receive a relatively weak signal);
the second sector S2 will receive (relatively strong) OWC signals output by the second front end 210b of the first AP 200a; and
the third sector S3 will not receive OWC signals (or will receive a relatively weak signal).

In this case, the EP 350 selects sector S2 for optimal connection to the first AP 200a via the second front end 210b.

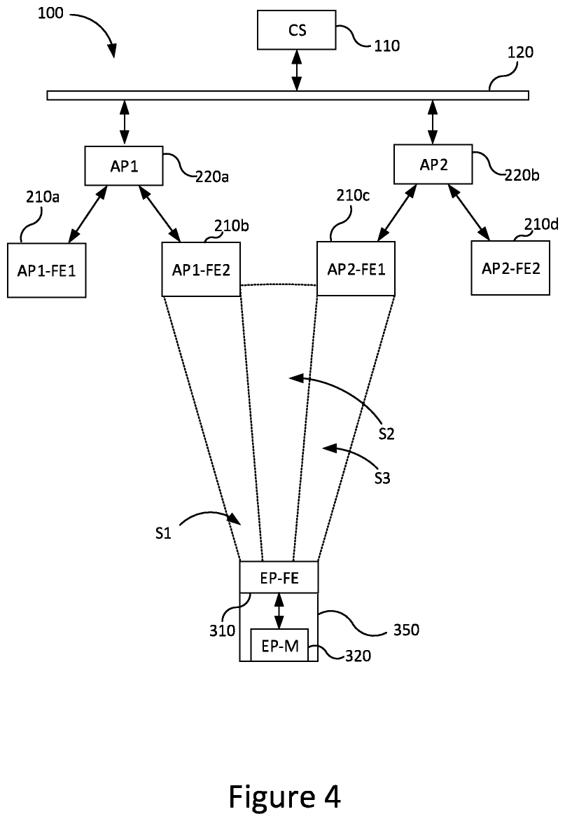

In FIG. 4, the EP 350 is positioned such that the second front end 210b of the first AP 200a is located within the first sector S1 and the third front end 210c of the second AP 200b is located within the third sector S3. No devices are present within the second sector S2. This means that:
the first sector S1 will receive (relatively strong) OWC signals output by the second front end 210b of the first AP 200a;
the second sector S2 will not receive OWC signals (or will receive a relatively weak signal); and
the third sector S3 will receive (relatively strong) OWC signals output by the third front end 210c of the second AP 200b.

In this case, the EP 350 may select both sector S1 and S3 at the same time if the modem 320 can handle the connection to both APs in parallel (e.g. a coordinated transmission under control of the control system 110). Otherwise, the EP 350 has a choice to either a) select sector S1 for optimal connection to the first AP 200a via the second front end 210b; or b) select sector S3 for optimal connection to the second AP 200b via the third front end 210c.

In particular, in the situation shown in FIG. 4, the EP 350 may currently be associated with the first AP 200a via the second front end 210b but will soon move to a position in which only the third front end 210c of the second AP 200b is in range. In this case, the OWC network 100 must implement a handover from the first AP 200a to the second AP 200b to enable ongoing connection to the OWC network 100. Handover between different APs 200 of the OWC network 100 requires cooperation between the control system 110 of the OWC network 100 and the modem 320 of the EP 350. Hence, it is important to maintain the current connection between the EP 350 and the second front end 210b of the first AP 200a until the handover is complete. If the decision regarding which sectors to use were left entirely up to the front end of the EP 350, which only basis its decision on signal strength values, this connection can be lost. For example, the front end may naively switch away from the first sector S1 when, for example, the signal strength of the third sector S3 becomes greater than that of the previous connection, because the front end does not know the importance of the connection of the first sector S1.

Examples described herein provide solutions to the above-mentioned problems.

FIG. 5 shows schematically an example receiver system 300 for receiving OWC signals in accordance with examples described herein. Control lines are shown dashed. The receiver system 300 is described herein as being implemented at the EP 350, but it is not excluded that the receiver system 300 may be implemented at another device of the OWC network 100 other than the EP 350. In particular, as will be described later, the receiver system 300 may be implemented at an AP 200. The EP 350 (or other device) may also comprise a transmitter system (not shown) for transmitting OWC signals to the OWC network 100.

The receiver system 300 comprises an optical front end 310 (also simply referred to herein as “front end”) and a modem 320. The modem 320 is operatively coupled to the front end 310.

The modem 320 comprises a plurality of input interfaces 321 for receiving OWC signals and an output interface 322. The interfaces may be referred to as “pins” and will typically correspond to the device pins that are allow input of a (high-bandwidth) modulated OWC signals to the demodulator. In FIG. 2, the modem comprises two input pins 321: a first input pin 321a and a second input pin 321b. In other examples, the modem 320 may have three or more input pins. The modem 320 may be implemented using any suitable circuitry.

Using the input pins, the modem 320 is able to receive a plurality of OWC signals simultaneously from the front end 310. The modem 320 analyses the received OWC signals and determines which one or more to use (to pass to the output pin 322). In particular, the modem 320 may select to use:
one OWC signal;
two (or more) OWC signals with time division or concurrently (e.g. when those OWC signals are coming from two different AP 200 modems 220); or
two (or more) OWC signals with MIMO (e.g. when those OWC signals are coming from the same AP 200 modem 220).

In the two (or more) OWC signals case, MIMO techniques may be used to combine the plurality of OWC signals. There may be some flexibility as to how the different paths are actually combined. The information (modulated data) over the two (or more) paths may be substantially identical or may be different. If the information is substantially identical, Maximal Ratio Combining (MRC) may be used to improve the signal quality. If the information is different, the signals of the different paths can be handled separately (and then combined after demodulation).

In the example of FIG. 5, the front end 310 comprises a plurality of photodetectors 311 for receiving OWC signals, a switch arrangement 313, and a selection unit 314. In use, the photodetectors 311 may receive OWC signals from for example one or more APs 220 as discussed above. The switch arrangement 313 is operatively coupled to the photodetectors 311 and the selection unit 314. The selection unit 314 may be implemented as one or more separate selection unit modules. The, or each, module may be implemented in any suitable manner, e.g. as software, hardware, or a combination of software and hardware.

The front end 310 may be implemented using any suitable circuitry. In other examples (not shown), the selection unit 314 may be implemented separately from the front end 310, or may be implemented at the modem 320.

In yet other examples, the selection unit 310 may be divided into a pre-selection unit and a final-selection unit, where the pre-selection unit considers the measured signals only (so without considering the assigned categories) and e.g. pre-selects only those segments for which the signal is strong enough. Such a pre-selection unit may be considered a “filter” in the sense that it can operate to remove any signals not reaching a predetermined threshold (e.g. a minimum signal strength, signal to noise, S/N ratio, etc.). For example, very weak signals may have a very bad S/N ratio and if blocked may improve the combined S/N ratio. The final selection unit then takes the measured signal strengths of the pre-selected signals and the assigned categories into account. Splitting the selection unit function in pre-selecting signals with some minimal signal strength (“strong enough”) and then make a final decision on the pre-selection reduces the complexity of the final-selection unit. The pre-selection unit may be implemented at the front end 310 and the final-selection unit may be implemented at the modem 320, though it is not excluded that they are both implemented at the front end 310, or modem 320.

The front end 310 is a “sectorised” front end in which the photodetectors 311 are arranged in a plurality of “sectors”. In this example, for the purposes of explanation, there are three sectors corresponding to the three sectors described above in relation to FIGS. 1-4. A first photodetector 311a provides the first sector S1, a second photodetector 311b provides the second sector S2, and a third photodetector provides the third sector S3. It is appreciated that there may be more sectors in other examples.

While in this example each sector comprises a single photodetector 311, it is appreciated that each sector may, in other examples, have more than on photodetector 311. Examples of suitable photodetectors include photodiodes, avalanche photodiodes, etc.

As mentioned above, the EP 350 (or other device) may also comprise a transmitter system (not shown) for transmitting OWC signals to the OWC network 100. In such cases, the modem may comprise a modulator and a demodulator. the transmitter system may be a sectorised transmitter system (comprising a plurality of light source, in a sectorised arrangement similar to the photodiodes described herein). In particular, the EP 350 (or other device) may be configured, when selecting a particular receive sector (one or more photodetectors), to select a corresponding one or more transmit sectors (one or more light sources) for transmitting signals. For example, one or more transmit sectors having a field of view substantially corresponding to the field of view of the currently-selected receive sectors may be used.

Each sector is operatively coupled to a respective input of the switch arrangement 313 such that, in operation, OWC signals received by the one or more photodetectors 311 of that sector are received by the switch arrangement 313 at a different respective input. Although not shown in FIG. 5, OWC signals received by each photodetector 311 may be amplified e.g. by a respective transimpedance amplifier (TIA) before being passed to the switch arrangement 313.

As will become clear, the implementation of the switch arrangement 313 depends on the particular communication setup. For example, the switch arrangement 313 may be implemented as:
a) Two (or more) multiplexers, each for passing a single OWC signal to a single respective pin 321, e.g. to connect the first photodetector 311a to the first pin 321a and the second photodetector 311b to the second pin 321b. In such cases, a maximum of two signals can be routed from the input, by selecting them individually and the modem 320 could determine how to use them; or
b) Two (or more) “conditional adders”, which are each capable of simultaneously passing two or more OWC signals to a single respective pin 321 (though they may pass a single OWC signal or indeed zero OWC signals). That is, each conditional adder is constructed and arranged to pass one or more OWC signals to a single respective pin 321. For example, a first conditional adder may connect both the first photodetector 311a and second photodetector 311b to the first pin 321a and a second conditional adder may simultaneously connect the second photodetector 311b and third photodetector 311c to the second pin 321b. The output of the conditional adders may be, for example, an average of the two or more signals it passes. Normalisation may be applied to the signal to avoid clipping, and this may be applied on either side of the conditional adders.

The adder may optionally attenuate a signal to control the contribution of the signal to the addition. E.g. this can be utilized to let a signal with a good SNR to contribute more to than a signal with poor SNR. So, instead of just binary selecting/de-selecting a signal to the adder, the selection unit—in cooperation with the modem—may determine the amount of contribution of a signal by controlling an attenuation-factor of the signal-relative to the other signal(s).

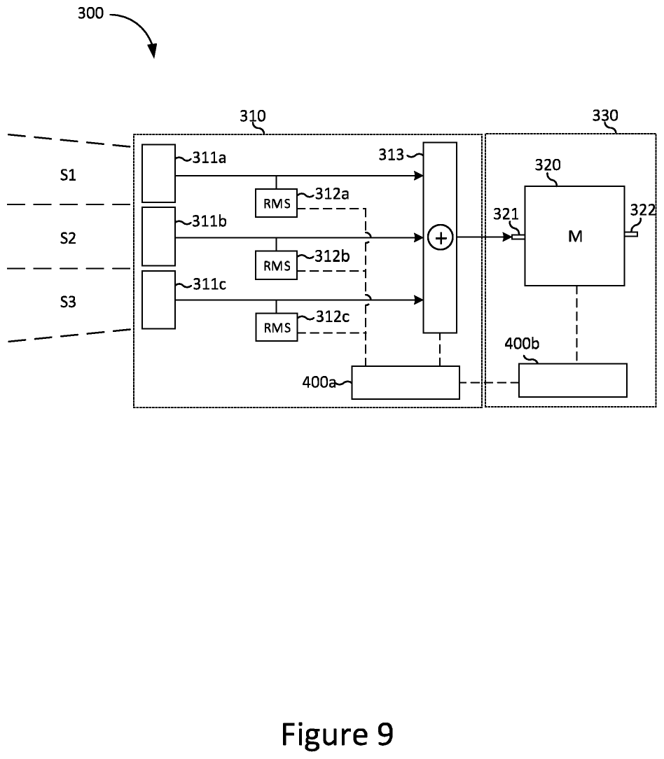

For simplicity, operation will first be described with reference to a multiplexer-type switch arrangement 313 (“a” above) which can only pass a single signal to a single pin 321. Examples in which the switch arrangement 313 may pass combinations of multiple signals to each pin 321 are described later with reference to FIG. 9.

The front end 310 comprises at least one signal strength detector 312 for measuring the signal strength of the OWC signals received via each sector. In the example of FIG. 5, there is one signal strength detector per sector: a first signal strength detector 312a for measuring the signal strength of OWC signals received by the first photodetector 311a; a second signal strength detector 312b for measuring the signal strength of OWC signals received by the second photodetector 311b; and a third signal strength detector 312c for measuring the signal strength of OWC signal received by the third photodetector 311c. In other examples, however, there may be a different number of signal strength detectors. Each signal strength detector 312 is operatively coupled to the selection unit 314 for enabling the selection unit 314 to determine the respective signal strengths of the received signals. Examples of suitable signal strength detectors include root-mean-square (RMS) detectors.

In operation, the selection unit 314 controls the switch arrangement 313 to selectively pass OWC signals received by the photodetectors 311 to the modem 320. Specifically, the selection unit 314 controls the switch arrangement 313 to pass a (different) one OWC signal to each input pin 321 of the modem 320. The modem 320 can then select one or more of these OWC signals to use (e.g. to demodulate and pass to the output pin 322). In general terms, the selection unit 314 may choose to “select” or “deselect” each OWC signal. The selected signals are the ones which are passed, or continued to be passed, to one of the input pins 321 of the modem 320. The deselected signals are not passed to the modem 320. Examples in which the selection unit 314 may choose to pass multiple OWC signals to each single pin 321 are discussed later below in relation to FIG. 9.

In accordance with examples described herein, the decision by the selection unit 314 of which OWC signals to select or deselect is based at least in part on a control signal received from the modem 320, in which the control signal indicates a category assigned by the modem 320 to each of the OWC signals. The selection unit 314 may update its decision once every control cycle, and/or according to a predefined schedule, e.g. once every second. The term “control cycle” used herein may relate to a characteristic period of the communication protocol being used. An example is the MAC cycle time of the ITU-G.9961 or ITU.G.9991 recommendation. For example, the modem may analyse a particular frame that is transmitted at minimum once every MAC cycle. So after ever cycle the measured RMS for that frame may be updated.

A control cycle can be defined as an action of the selection unit in cooperation with the modem to make a decision for controlling the switch arrangement. For example, the selection unit may start a control cycle by selecting a new signal and indicating this change to the modem; after analysing the signal, the modem responds to the selection unit with a recommendation for the new signal (which can be an indication of accepting/rejecting the signal); the selection unit completes the cycle by acting accordingly to the response. Control cycles may (but not necessarily) run synchronously with the MAC cycles, assumed that the modem can analyse a signal within a MAC cycle.

The modem 320 does not necessarily know exactly which OWC signals from photodetectors 311 are being passed to the respective input pins 321. Hence, the modem 320 may indicate a category for each respective input pin 321, rather than directly for the OWC signals themselves. The selection unit 314 interprets a category assigned to a given input pin 321 as applying to the OWC signal (or signals, see FIG. 9) currently being passed to that input pin 321.

Various types of category are possible. The selection unit 314 is configured to treat OWC signals having each type of category differently. In general terms, the categories are labels to be used by the selection unit 314. In examples, a category may alternatively by called a priority, rank, score, class, or level. In some examples, the categories are numerical, increasing (or decreasing) monotonically according to for example the “importance” or “usefulness” of the OWC signal concerned.

A first example category is a “keep” category. The selection unit 314 may be configured so as to not to deselect any OWC signal having the keep category. The modem 320 may assign the keep category, for example, to an OWC signal that the modem 320 is currently using to connect to the OWC network 100.

A second example category is a “de-selectable” category. The selection unit 314 may be configured so as to allow to deselect any OWC signal having the de-selectable category. The modem 320 may assign the de-selectable category, for example, to an OWC signal that the modem 320 is not currently using to connect to the OWC network 100.

These two examples (“keep” and “de-selectable”) represent a simple “binary” case in which the modem 320 indicates to the selection unit 314 which OWC signals it must keep and is not to deselect and which ones it is allowed to deselect. In reality, the modem 320 may only assign, for example, the keep category to one or more of the OWC signals, and the fact that the other OWC signals are assigned the de-selectable category is not assigned as such and is implicit by the absence of an assigned category.

It is appreciated that, depending on e.g. the assigned categories, the number of sectors, and the number of input pins 321 to the modem 320, the selection unit 314 may have some freedom to select or deselect different OWC signals. When this is the case, the selection unit 314 uses the measured signal strengths (using one or more signal strength detectors 312, e.g. as in the example of FIG. 5) to determine which (allowed) OWC signals to select/deselect. For example, if the modem 320 assigns the keep category to sector S2, the de-selectable category being either explicitly or implicitly assigned to sectors S1 and S3, the selection unit 314 continues to pass sector S2 to (the same input pin 321 of) the modem 320 and selects the one of sector S1 and S3 having the highest signal strength to pass to (the other input pin 321 of) the modem 320.

An advantage of this system is particularly apparent when considering the handover situation described above in relation to FIG. 4. In this situation, the modem 320 is using the first sector S1 to communicate with the OWC network 100. The modem 320 can assign the keep category to sector S1, which means that the selection unit 314 will not deselect sector S1 even if or when the signal strength from sector S3 becomes greater. This means that the modem 320 maintains its connection to the OWC network 100 for implementing the handover to the second AP 200b

The notion of a category may be extended beyond the simple “binary” example, as discussed below.

A third example category is a “preferably-keep” category. The selection unit 314 may be configured to only deselect any OWC having the preferably-keep category in exceptional circumstances, e.g. when the signal strength of that OWC signal is very low (below some threshold) and/or another OWC signal is much stronger (for example, some threshold percentage stronger). In the latter case, for example, the selection unit 314 may swap out the OWC signal having the preferably-keep category for the other OWC signal (i.e. deselect the OWC signal having the preferably-keep category, and select instead the other OWC signal). The modem 320 may assign the preferably-keep category, for example, to an OWC signal that the modem 320 is not currently using to connect to the OWC network 100 but has a good signal to noise ratio and/or signal to interference ratio.

A fourth example category is a “discard” category. The selection unit 314 may be configured to deselect any OWC signal having the discard category. Note that this is distinguished from the “de-selectable” category in that the decision to deselect is dictated by the modem 320, rather than being left up to the selection unit 314.

In examples, the categories may alternatively or additionally be associated with a numerical value. For example, the categories may be “priorities”, with a higher priority OWC signal having a higher numerical value. The selection unit 314 may then select OWC signals based on maximising the sum of these numerical values for all the OWC signals or using some other similar mathematical formulation (such as a sum of the squares of the priorities, etc.). Note that alternatively the higher priorities may have a lower numerical value, in which case the selection unit 314 may operate to minimise the sum.

In one example, the selection unit 314 may identify the OWC signal having the lowest priority from the currently selected OWC signals and deselect it. The selection unit 314 may replace this OWC signal with the OWC signal having the highest signal strength from the currently deselected OWC signals (i.e, select that OWC signal instead). Put simply, the selection unit 314 may “swap out” the lowest priority OWC signal for the best alternative OWC signal. In another example, the selection unit 314 may perform a similar process but wherein two or more OWC signals are “swapped out”.

Table 1, below, summarises some example categories.

TABLE 1

| Category | Category | | |
|---|---|---|---|
| Rank/Value | Type | Meaning | Selection unit 314 action |
| 1 | Keep | Not allowed | Keep the OWC signal |
| | signal | to de-select | connected |
| 2 | High | Preferably keep | Only deselect the OWC |
| | priority | | signal in exceptional cases, |
| | | | e.g. when the current signal |
| | | | is very weak and/or another |
| | | | signal is much stronger |
| 3 | Low | Allowed to | Attempt to find a better |
| | priority | de-select | signal. As long as the |
| | | | indication remains low |
| | | | priority, the selection unit |
| | | | 314 may alternate between |
| | | | multiple signals |
| 4 | Non-usable | De-select | Change to another signal |
| | signal | | |

Now will be described some illustrative examples of how the modem 320 may assign the categories of Table 1 in different scenarios.

First consider a modem 320 having two input pins 321, as in FIG. 5, wherein the selection unit 314 is controlling the switch arrangement 313 to pass a first (one or more) OWC signal to the first pin 321a and a second (one or more) OWC signal to the second pin 321b.
Scenario 1: the modem 320 is currently using the first OWC signal to connect to the OWC network 100 and is not using the second OWC signal. In this scenario, the modem 320 may assign, for example, category #1 (“keep”) to the first OWC signal and category #2, #3, or #4 to the second OWC signal.
Scenario 2: the modem 320 is currently using the first OWC signal to connect to a first AP 200 and the second OWC signal to connect to a second AP 200. This may be the case during a handover (see, for examples, FIG. 4 described above). In this scenario, the modem 320 may assign category #1 to both the first signal and the second signal during the handover to ensure that both connections are maintained. Prior to the handover, the modem 320 may assign e.g. category #2 to the second signal in preparation for the handover from the first AP 200a to the second AP 200b.
Scenario 3: the modem 320 is currently using both the first and second OWC signals to connect to a single AP 200 (in for example a MIMO connection). In this scenario, the modem 320 may assign category #1 to the first and second signals. If the modem 320 is currently using both the first and second OWC signal but not for a MIMO connection (e.g. a single duplicated stream), it may, for example, assign category #1 to the first signal and category #2 to the second signal.

Next consider a modem 320 having three input pins 321, wherein the selection unit 314 is controlling the switch arrangement 313 to pass a first (one or more) OWC signal to the first pin and a second (one or more) OWC signal to the second pin, and a third OWC signal to the third pin.
Scenario 1: the modem 320 is currently using the first OWC signal to connect to the OWC network 100 and is not using the second or third signal to connect to the OWC network 100. In this case, the modem 320 may assign category #1 to the first signal, and assign category #2, #3, or #4 to each of the second and third signals. The specific choice of category for the second and third signals may depend on for example the signal to noise ratio of each of the second and third signals.
Scenario 2: the modem 320 is currently using the first OWC signal to connect to a first AP 200, the second OWC signal to connect to a second AP 200, and is not using the third OWC signal. This may be the case during a handover (see, for examples, FIG. 4 described above). In this scenario, the modem 320 may assign category #1 to both the first signal and the second signal during the handover to ensure that both connections are maintained. The modem 320 may assign any of categories #2, #3, #4 to the third signal, depending on e.g. the signal strength of the third signal. Prior to the handover, the modem 320 may assign e.g. category #2 to the second signal in preparation for the handover from the first AP 200a to the second AP 200b.
Scenario 3: the modem 320 is currently using both the first and second OWC signals to connect to a single AP 200 (for example in a MIMO connection). In this scenario, the modem 320 may assign category #1 to the first and second signals. The modem 320 may assign any of categories #2, #3, #4 to the third signal, depending on e.g. the signal strength of the third signal. If the modem 320 is currently using both the first and second OWC signal but not for a MIMO connection (e.g. a single duplicated stream), it may, for example, assign category #1 to the first signal and category #2 to the second signal.

It is appreciated that similar concepts may be extended to a modem 320 having any number of input pins 321. Consider a modem 320 having N input pins 321, wherein the selection unit 314 is controlling the switch arrangement 313 to pass a first (one or more) OWC signal to the first pin and a second (one or more) OWC signal to the second pin, a third OWC signal to the third pin . . . and an Nth OWC signal to the Nth pin.
Scenario 1: the modem 320 is currently using the first OWC signal to connect to the OWC network 100 and is not using any of the other N−1 signals to connect to the OWC network 100. In this case, the modem 320 may assign category #1 to the first signal, and assign category #2, #3, or #4 to each of the other N−1 signals. The specific choice of category for the other N−1 signals may depend on for example the signal strength of each of the N−1 signals.
Scenario 2: the modem 320 is currently using the first OWC signal to connect to a first AP 200a, the second OWC signal to connect to a second AP 200b, and is not using any of the other N−2 signals. This may be the case during a handover (see, for examples, FIG. 4 described above). In this scenario, the modem 320 may assign category #1 to both the first signal and the second signal during the handover to ensure that both connections are maintained. The modem 320 may assign any of categories #2, #3, #4 to the other N−2 signals, depending on e.g. the signal strength of the other N−2 signals. Prior to the handover, the modem 320 may assign e.g. category #2 to the second signal in preparation for the handover from the first AP 200a to the second AP 200b.
Scenario 3: the modem 320 is currently using both the first and second OWC signals to connect to a single AP 200 (for example in a MIMO connection). In this scenario, the modem 320 may assign category #1 to the first and second signal. The modem 320 may assign any of categories #2, #3, #4 to the other N−2 signals, depending on e.g. the signal strength of the other N−2 signals. If the modem 320 is currently using both the first and second OWC signal but not for a MIMO connection (e.g. a single duplicated stream), it may, for example, assign category #1 to the first signal and category #2 to the second signal.

In the receiver system 300 as described above the control interface is unidirectional (modem 320 to front end 310). In other examples, the interface may be bidirectional. To minimize wiring and the required number of pins on a chip, a serial interface may be used. When all controllers are distributed over the system and connected via cables, as in some examples described herein, the required number of wires in the cable could become an issue (e.g. in terms of cost). Hence, in examples the control interface may be combined with other wiring. For example:
Signal wires: In this case we need a to arrange that the control communication does not interfere with the signal itself e.g. by using and out-of-band signalling for the control interface
Power wiring: When for example all the AP-FEs are powered via the FE-adder, the wiring for that purpose could also be used for control communication.

As will be appreciated, use of a bi-directional control interface can be advantageous for many reasons. For example, the selection unit 314 may indicate to the modem 320, for a given input pint 321, when it changes the OWC signal being supplied to that input pin 321. The modem 320 can use this “new” indication or flag to restart assessing the quality of the signal onto the input pins 321 (e.g. by assessing the pin or pins which have the “new” indication first). For example, when the modem 320 indicates Low Priority or Non-usable (categories #3 and #4 above) for an input pin, the selection unit 314 can initiate a search for a new signal, provide the new signal to that pin 321 of the modem 320 along with an indication that the signal is new. By flagging to the modem 320 that a new signal is supplied, the modem 320 starts an assessment.

In a specific example, when the modem 320 indicates Low Priority or Non-usable (categories #3 and #4 above) for all signals, the selection unit 314 can initiate a search for a new signal, provide the new signal to 321 of the modem 320 along with an indication that that signal is new. By flagging to the modem 320 that a new signal is supplied, the modem 320 starts an assessment. That is, the selection unit 314 is configured to search for a new OWC signal if none of the currently selected OWC signals is assigned a category by the modem 320 that indicates that the OWC signal is not to be deselected or is preferably to be kept, and to provide an indication of the new OWC signal to the modem 320, the modem 320 being configured to analyse the new OWC signal next on receipt of the indication.

This is particularly advantageous, for example, in the situation that the front end 310 may choose out of many segments having a high signal strength. The selection 314 unit may provide all these signals, e.g. sequentially, to the modem 320 on one (or multiple) pins 321. However, it is possible that the selection unit 314 may do this too fast, not giving the modem 320 enough time to examine each new signal in sufficient detail to assign the proper category on each new signal. By flagging that the signal selection changed (signal is “new”), the modem 320 can, for example, assign a “hold” category (which may be the “keep” category from above) preventing the selection unit 314 from cycling away from that signal. Once the modem 320 has analysed the signal well enough, it can assign a final category, depending on its assessment. In this way, the selection unit 314 will step through the sequence of signals in a tempo that fits to the modem 320.

This is also advantageous in cases, for example, in which none of the OWC signals are assigned the “keep” category by the modem 320. The selection unit 321 may select the OWC signal having the highest signal strength out of the OWC signals currently de-selected, and pass this OWC signal to one of the input pins 321 of the modem 320. The selection unit 314 can provide an indication to the modem 320 of the input pin 321 to which the new OWC signal has been supplied. The modem 320 can then analyse or assess this new OWC signal first to attempt to connect to the OWC network 100.

The fact that the modem 320 is currently assessing the viability of the new OWC signal may be conveyed to the selection unit 314. For example, this may be done using a dedicated category type: “Keep the signal for assessment”, which could be an indication between priority #1 and #2 of Table 1 above. Alternatively, the modem 320 can simply apply category #1 (keep) for the time that it is executing the assessment. After the assessment, the modem 320 can assign one of the categories as described above.

In examples, instead of using a “hold” indication explicitly, the protocol between selection unit and modem may be arranged such that the selection unit keeps a newly selected signal (“hold” implicitly) until it receives a notification from the modem for this newly selected signal. The notification can be a recommendation for the signal, but also an accept/reject indication.

The described communication is preferably done via a bi-directional serial interface. In this manner the number of required wires between the modem 320 and selection unit 314 stays limited. The selection unit 314 acts as the master and the response of the modem 320 defines the next step of the selection unit 314.

As both the selection unit 314 and modem 320 need to send control signals for every individual input pin 321 of the modem 320, it is efficient to combine these control signals in a single message. This minimizes overhead in the communication which has a positive effect on communication speed.

The above has been described substantially in relation to the receiver system 300 being implemented at the EP, it is appreciated that the receiver system 300 may in practice by implemented at any device that has at least one front end and a modem. Wherever the receiver system 300 is implemented, the features and advantages described above apply.

In a specific example, the receiver system 300 may be implemented at an AP 200. In this case, the front end 310 corresponds to an AP front end 210 and the modem 320 corresponds to the AP modem 220. One reason that the receiver system 300 is advantageous when implemented at an AP 200 is that, although the AP 200 is fixed, a moving EP 350 may still result in the need to use different segments from the AP front end 310.

There are two main differences when implementing the receiver system 300 at an AP 200 rather than an EP 350:
A: while the modem of an EP typically only needs to communicate with a single AP modem (except during handover, for example), the modem 320 of the AP 200 typically needs to deal with more EPs 350. That is, unlike an EP, which typically only communicates with a single AP at any given time, an AP may be in communication with multiple EPs simultaneously;
B: an AP may have more than one front end (although it is not excluded that an EP could also have more than one front end).

These two differences are discussed in turn below.

Consider first cases in which the AP modem 320 may wish to communicate with a plurality of EPs at the same time. In examples, the modem 320 may communicate categories based on the selected EP 350 with which the modem 320 wants to communicate. Specifically, the selection unit 314 may apply a different selection of signals for each EP and assess the signals of its segments for each EP separately. Such different process of the selection unit 314 for each EP could be labelled as operating in a different mode. In short, the selection unit 314 may support multiple “modes” whereby each mode corresponds with a single EP with which the AP 200 is currently communicating. A further mode may be provided to accommodate for the situation whereby the AP 200 does not pre-select to communicate with a particular EP. Each time that the transmission changes from one EP to a next EP, the selection unit 314 changes its mode. At such change, it stores the state of the current process and fetches the state of the next process.

In case the modem 320 wants to communicate with multiple EPs 350, an additional category may be used, e.g. select all segments. The selection unit 314 may be configured so as not to be able to deselect any of the segments if the select all recommendation is assigned by the modem 320 (to any of the signals).

Since the selection unit 314 has no intrinsic information about which EP is transmitting at which moment, it depends on the provision of that information by the modem 320. The MAC protocol (considered to be implemented in the modem 320), comprises the information when which EP transmits a signal.

The modem 320, knowing with which EP(s) it communicates at which time, indicates to the selection which process it must activate at which time.

This might be arranged by the modem 320 communicating a TDMA schedule. It might also be arranged by the modem 320 indicating which process the selection unit 314 must activate next followed by a trigger indicating the actual time to switch to the new process.

In the communication from modem 320 to selection unit 314, the modem 320 may apply a mode-identifier corresponding to each EP and the selection unit 314 may apply a different mode of operation for each mode-identifier.

In case the modem 320 applies a TDMA schedule that determines when which EP is transmitting, it may provide the selection unit 314 with a corresponding schedule of mode-identifiers determining when the selection unit 314 should apply which operation mode.

In other situations, the modem 320 may provide the corresponding new mode-identifier to the selection unit 314 for each time that another EP starts transmitting. The modem 320 may also trigger the start time and end time of such transmission to the selection unit 314. The modem may even select a particular start and end time within the transmission time of the EP, e.g. it may indicate/trigger the start and end time corresponding to a particular frame. These start and end time indications can help the selection unit 314 to make a good decision in its selection process. These indications in particular can help the FE for assessing the RMS value of the received signals at its segments.

Similar as for the case of the EP, the selection unit 314 may change the selection of the signals for that mode for an input pin, at each control cycle, e.g. at every MAC-cycle. For example, although the selection unit 314 changes the selection of its signals within a MAC-cycle corresponding to the transmitting EPs, it may update the selection for a particular EP once every control cycle, e.g. once every MAC-cycle.

An AP typically transmits a protocol defined signal for sharing information with any EPs receiving the signal (e.g. beacon-frame, MAP frame) every MAC cycle, which enables the EP modem to analyse that signal every MAC-cycle. Hence, when implemented at an AP, the AP cannot rely on such signal coming from the EPs, but is dependent on when the EP is transmitting (which it may know when e.g. a TDMA schedule is applied). In any case, when an EP is transmitting in a MAC cycle, the modem would be able to analyse the signal in that MAC cycle and hence a control cycle for that EP may be completed in for that MAC-cycle. So, in every MAC-cycle, the selection unit and modem may run a control cycle for each EP that is transmitting.

Different from the case of the EP is that an EP may not transmit a signal in every MAC-cycle meaning that the selection unit can only update the selection for a particular EP when the EP transmits in a MAC-cycle. In other words, the selection unit typically updates the selection for a subset of EPs once every MAC-cycle, whereby the subset of EPs is determined by the EPs transmitting in a particular MAC-cycle.

As noted, another difference between implementing the receiver system 300 at an AP 200 rather than an EP 350 is that an AP 200 may have multiple front ends 310. The modem 320 may apply the above-described methods in relation to each front end 310 separately in order to keep track on the signal quality of the selected signals for each front end 310, for each EP 350. Various examples are given below. Elements of the receiver system 300 which are substantially the same as described above are not described in detail again.

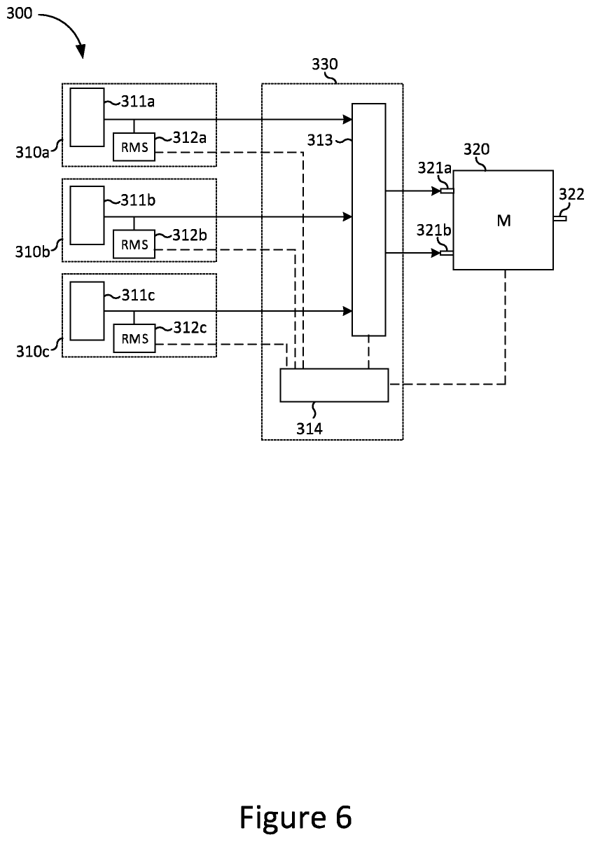

FIG. 6 shows schematically an example in which the receiver system 300 is implemented at an AP having a plurality (three, in this example) of optical front ends 310a-c, each front end having a single respective segment 311a-c and signal strength detector 312a-c.

In this example, the switch arrangement 313 is not implemented at the front end, or indeed any of the front ends, as in previous example. Rather, the switch arrangement 313 is implemented at a “front end adder” 330. The front end adder 330 may be implemented centrally, e.g. near the modem 320 of the AP, or may be implemented as a separate unit elsewhere.

Each front end 310a-c is operatively coupled to a different respective input of the switch arrangement 313 in a similar manner to described above. Each signal strength detector 312 is also operatively coupled to the selection unit 314 in a similar manner to described above. The selection unit 314 may be implemented at the front end adder 330 or may be implemented elsewhere. In particular, as explained in more detail below with reference to FIG. 9, the functionality of the selection unit 314 may be split over a front-end controller 400a and a modem controller 400b.

This example differs from previous examples in that the front ends 310a-c (and new front end adder 330) are not embedded in the same housing but are physically separated. This allows, for example, a physical separation of the front ends 310a-c e.g. in different places within a ceiling of a room (cf. FIG. 1).

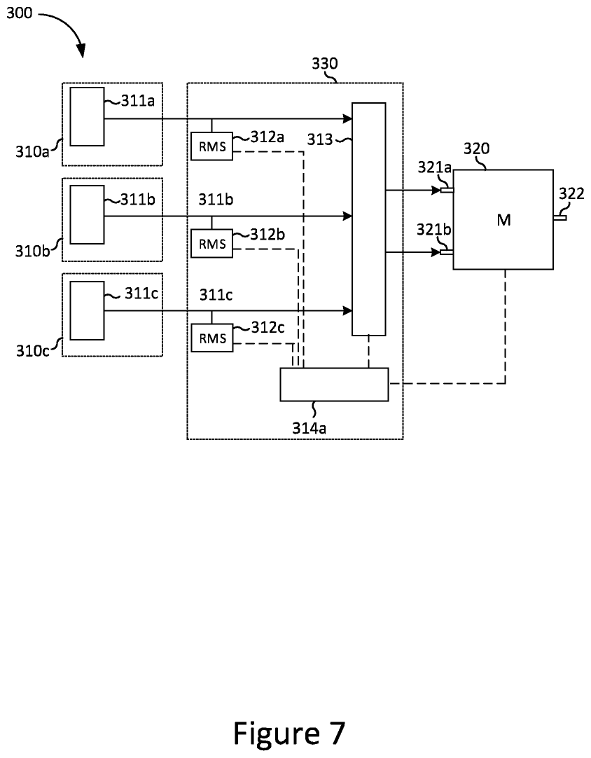

FIG. 7 shows schematically a similar example to that of FIG. 6, except that the signal strength detectors 312 are implemented at the front end adder 330 along with the selection unit 314. An advantage of this arrangement is that the wiring connecting the signal strength detectors to the selection unit 314 can be made shorter.

Both FIGS. 6 and 7 show two input pins 321 of the modem 320. However, it is appreciated that similar considerations apply in relation to a modem 320 having any number of pins 321.

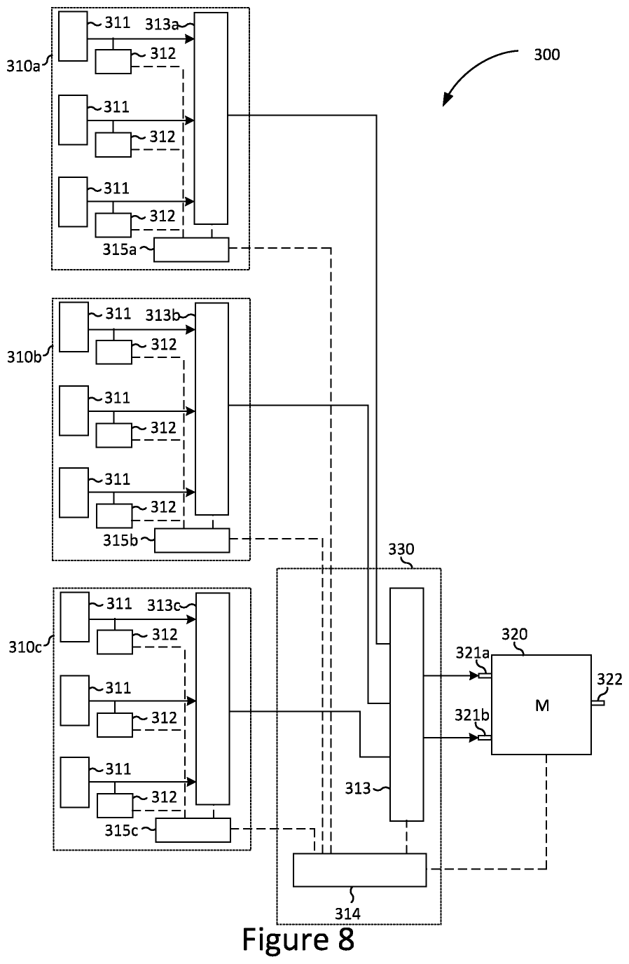

FIG. 8 shows schematically an example in which the receiver system 300 is implemented at an AP comprising a plurality (three in this example) of optical front ends 310a-c, each front end 310 having a respective plurality of segments 311.

Each front end 310 has a respective switch arrangement 313a-c connected to the plurality of sectors 311 in a similar manner to as described above. Each front end 310 also has a respective front end controller 315. The front end controller 315 of each front end 310 is operatively coupled to the switch arrangement 313a-c and to a signal strength detector 312 of each sector 311. It is appreciated that this is similar to the arrangement and construction of the selection unit 314 described above.

In this example, the switch arrangement 313a-c of each front end 310 has only a single output. The (single) output of the switch arrangement 313a-c of each front end 310 is operatively coupled to a different respective input of the switch arrangement 313 of the front end adder 330. In other examples, the switch arrangement 313a-c of one or more of the front ends 310 may comprise two or more outputs which are each connected to a different respective input of the switch arrangement 313 of the front end adder 330. In any case, each front end controller 315a-c is also operatively coupled to the selection unit 314, e.g. arranged via a separate serial interface, by Out-of Band (OOB) communication over the signal interface, etc.

In operation, the front end controller 315 of each front end 310 provides information on the signal strength of each segment to the selection unit 314 via its control interface. Such information may be provided on initiative of a front end controller 315. Alternatively, the selection unit 314 may control these information flows by regularly requesting each front end controller 315 to provide the actual state of the signal strengths.

With the information available on all received signals, the selection unit 314 may apply the same protocol as described in any of the examples given herein.

It will be appreciated that some control solutions require bi-directional control while other solutions only need an uni-directional version. To minimize wiring and the required number of pins on a chip, a serial interface is preferred. When all controllers (front end controllers 315, selection units 314, adder controllers and modem controllers described below) are distributed over the system and connected via cables, like in FIG. 8 Error! Reference source not found, the required number of wires in the cable could become an issue (e.g. in terms of cost). For that kind of situations, the control interface could be combined with other wiring:
Signal wires: In this case we need a to arrange that the control communication does not interfere with the signal itself e.g. by using and out-of-band signalling for the control interface
Power wiring: When for example all the AP-FEs are powered via the FE-adder, the wiring for that purpose could also be used for control communication.

As mentioned earlier above, in some examples the selection unit 314 may choose to pass multiple OWC signals to each single pin 321. This applies in relation to any of the examples above (i.e. in relation to both either an EP or an AP implementation).

This means that a combination can be selected from the input for two pins separately, while at the same time the modem 320 can analyse signals on one or more other pins 321. This will now be described in more detail.

FIG. 9 illustrates an example of the receiver system 300 in which multiple OWC signals may be passed to a single pin 321 of the modem 320. Also in this example, the functionality of the selection unit 314 is split over a front end controller (FE-controller 400a) and a modem controller (M-controller 400b). This partitioning may also be advantageous in the earlier examples.

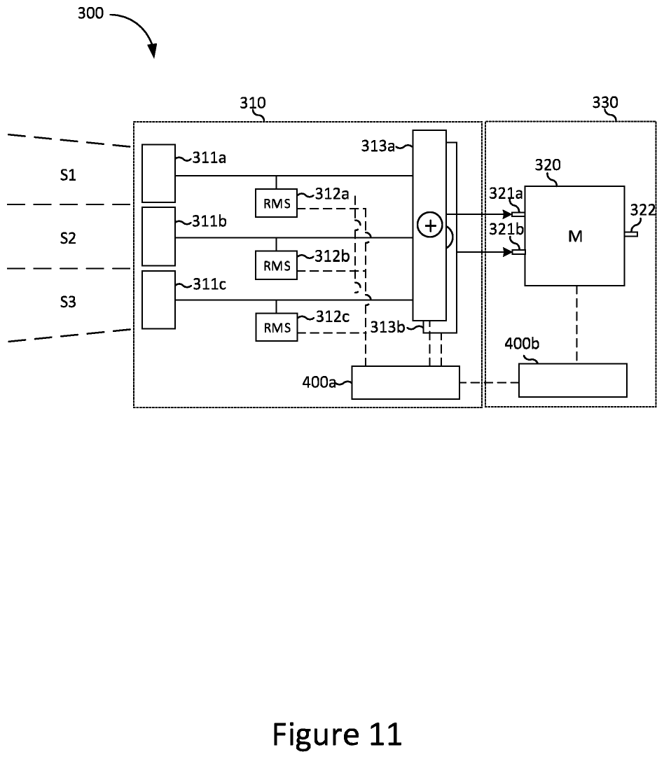

It is appreciated that the description is given with reference to a single input pin 321 of the modem 320 only for the sake of clarity, but that the selection unit may provide combinations of plural OWC signals to multiple pins 321 simultaneously. Examples in which multiple OWC signals may be provided are described later below in relation to FIG. 11. In FIG. 9, the FE-controller 400a is implemented at the front end 310. A modem end 330 is provided which comprises the M controller 400b and the modem 320 itself. This will be described in more detail below. It is appreciated that the receiver system 300 of FIG. 9 may be implemented at either the EP 350 or an AP 200. These options will be discussed in turn.

First, consider the receiver system 300 of FIG. 9 implemented at the EP 350.

A bi-directional control interface is provided between the FE-controller 400a of the front end 310 and the M-controller 400b of the modem end 330.

The FE-controller 400a has three types of interfaces
1. Measured signal strengths
2. Selection of signals for the adder
3. Control Interface with M-controller 400b

The M-controller 400b has two interfaces
1. Received signal quality e.g. SNR, SIR, SNIR
2. Control interface with FE-controller 400a

The control channel between FE-controller 400a and M-controller 400b is a preferably realised with a bi-directional serial interface. In this manner the number of required wires/connectors for this channel is limited. Additional wiring for the control channel may even be omitted by re-using the wires of the signals by using out-of-band techniques e.g. by applying frequency division.

The FE-controller 400a assigns an identifier to each OWC signal to support the communication over the control channel. A control message typically contains such an identifier, with in addition information like adding/removing the signal to/from the adder and optionally the measured strength of the signal.

As mentioned, the FE-controller 400a may control the switch arrangement 313 to pass multiple OWC signals to a single pin 321 of the modem 320. (i.e. the switch arrangement 313 may be implemented as an adder.) That is, the FE controller 400a may control the switch arrangement 313 to connect the photodetectors 311 of two or more sectors to the same pin 321 of the modem 320. The combined signal received by the modem 320 on that pin 321 in such cases will be a superposition of the two (or more) constituent OWC signals.

In examples, the adder 313 may amplify/attenuate a signal to control the contribution of the signal to the combined signal.

Once multiple OWC signals are added as combined signal to the modem 320, the modem 320 can no longer easily differentiate these OWC signals. However, the modem 320 can assess the contribution of an OWC signal to the combined signal when this signal is added or removed from the switch arrangement 313. Therefore, each time that the FE-controller 400a changes the selection of the signals, the M-controller 400b should be informed of this change. This may be achieved using control cycles, as will be explained below.

In some examples, the FE-controller 400a may initiate a control cycle for changing the selection of signals to be added. In another example, the M-controller 400b may also initiate a control cycle for changing the selection of signals to be added. (In general, either the FE-controller 400a of the M-controller 400b may initiate a control cycle.)

Control cycles for the same external transmission source are preferably handled sequentially, meaning that a new control cycle should not be initiated during the execution of a current control cycle. In case both the FE-controller 400a and M-controller 400b co-incidentally initiate a control cycle at the same time, the control cycle initiated by the M-controller 400b may be executed and that of the FE-controller 400a aborted. This prevents control cycle conflict.

Control cycles instigated by each of the FE-controller 400a and M-controller 400b will now be discussed in turn.

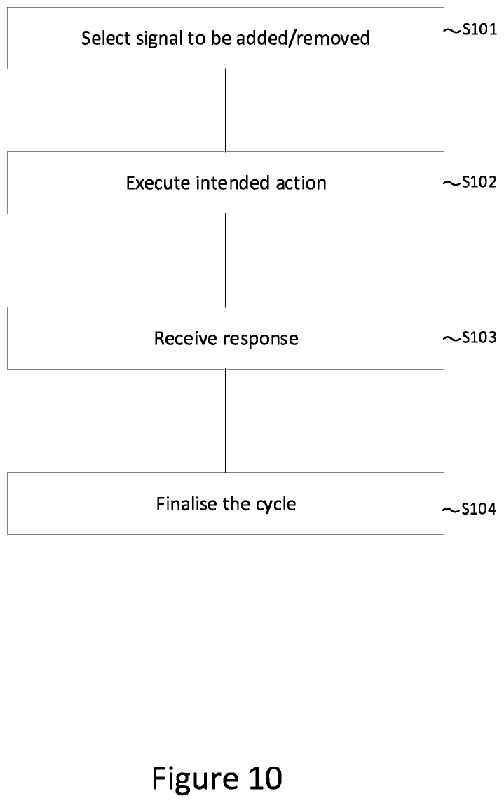

FIG. 10 shows an example method of implementing a control cycle initiated by the FE-controller 400a.

At S101, the FE-controller 400a selects a signal to be added to or to be removed from the switch arrangement 313. The FE-controller 400a communicates the corresponding intended action to the M-controller 400b by sending a message carrying the information of the selected signal and whether this signal will be added or removed. (Optionally the FE-controller 400a selects multiple signals and indicate in the message for each signal whether it will be added or removed)

At S102, the FE-controller 400a executes the intended action of the previous step S101. The time of executing the action is preferably aligned with the end of the message indicating the action. Alternatively, the moment of the action may be indicated by a separate message either send by the FE-controller 400a or by the M-controller 400b. The FE-controller 400a then waits on the response of the M-controller 400b before taking any further action. In other words, the FE-controller 400a may “keep” (without explicit recommendation from the modem) the signal selected until later order. Therefore, the FE-controller 400a should not start a new control cycle before it receives a response from the M-controller 400b, because it might otherwise replace the signal with another one before the M-controller 400b has completed its analysis of the signal.

At S103, the FE-controller 400a receives a response from the M-controller 400b. The response follows the M-controller 400b having analyses the effect of the action of S102. In particular, the M-controller 400b responds to the FE-controller 400a whether it accepts or rejects the change. Instead of such binary (accept/reject) response, the M-controller 400b may provide a recommendation as described before. It may also indicate an attenuation factor indicating how much the signal should relatively contribute to the adder.

At S104, on reception of the response from the M-controller, the FE-controller finalizes the cycle. In case of a reject response, the FE-controller 400a inverts the action of S102 and internally marks this signal as rejected, otherwise it maintains the signal added to the passed signal(s) from S101 and if applicable indicates an attenuation factor for the signal to the adder

As mentioned, a control cycle may also be initiated by the M-controller 400b. A pre-requisite for this is that the FE-controller 400a has provided the M-controller 400b information on the availability of multiple signals and an identifier per signal. In such cases, the M-controller 400b selects one or multiple signals to be added or removed and communicates this as a command to the FE-controller 400a. After reception of the command from the M-controller, the FE-controller adds and removes the signals to and from the adder according to the command.

Having disclosed examples of how and when the FE-controller 400a and M-controller 400b may instigate and/or accept/reject changes to the signal(s) provided to a pin 321 (again, this can apply to any one or more pins of the modem 320), it will now be described by way of example a process of finding an optimal set of signals to pass to the pin 321. The perspective of the receiver system 300 being implemented at the EP is maintained. Examples relating to an AP receiver system 300 are described later below.

Consider the case that the FE-controller 400a currently has no signal selected as input for the switch arrangement 313. The FE-controller 400a indicates this state to the M-controller 400b by sending a message that no valid signal is available.

In this initial state, the FE-controller 400a monitors incoming signals (their signal strengths). If at least one signal has a signal strength which is above a first threshold, the FE-controller 400a selects the signal with the highest signal strength and initiates a control cycle (described above) to provide this signal to the pin 321 (or, in other examples, add this signal to the one or more signals already being provided to that pin 321).

If instead (e.g. at a later point in time) the FE-controller 400a has at least one input signal actively selected, then the FE-controller 400a can again monitor incoming signals. In this case, if the FE-controller 400a detects one or more signals above the first threshold that are currently not selected (and not rejected, as discussed in relation to FIG. 10), then the FE-controller 400a may select from those signals the signal with the highest signal strength and provide this signal to the pin 321 (or, in other examples, add this signal to the one or more signals already being provided to that pin 321).

The effect of this new signal (or signals) is then assessed by the modem 320.

If the modem 320 considers the change an improvement, the modem 320 indicates this to the M-controller 400b. The M-controller 400b can then respond to the FE-controller 400a with an “accept” indication. The modem 320 may consider a change resulting from a new signal to be an improvement if, for example, the signal-to-noise ratio increases. This may be the case, for example, if the new signal originates from a same external device (an AP, in this case) as one of the current signals on the pin 321 (as the same information will be carried).

If instead the modem 320 considers the change a degradation (e.g. if the second signal originates from a different AP interfering with the first signal and so the signal to interference ratio decreases), the M-controller 400b responds with a reject and marks this signal as rejected.

The FE-controller 400a may repeat the process described above until all signals above the first threshold have been examined.

Optionally, when adding a new signal, the FE-controller 400a may configure the adder to attenuate the signal to reduce its relative contribution. This is of advantage to mitigate the interference of a signal when it is originated from a different external device than the device for which the current signals are selected. The FE-controller may indicate to increase the contribution of the signal after it has received an accept from the M-controller and if applicable according to additional information it receives from the M-controller.

The set of one or more OWC signals constituting the optimum choice may change over time. This can be, e.g. due a change of position of the EP relative to an AP or to multiple APs. Hence, the FE-controller 400a may implement a process of adapting the set of signals to account for this changing situation.

As a first example, if the strength of a signal that was previously below a threshold rises above a threshold, the FE-controller 400a may initiate a control cycle to add this signal to the pin 321 via the switch arrangement 313.

As a second example, if the strength of a currently selected signals falls below a second threshold, the FE-controller 400a may initiate a control cycle to remove this signal from the pin 321.

As a third example, if the strength of a signal previously marked as rejected, increases (e.g. becomes larger than one or more of the currently selected signals), the FE-controller 400a may re-initiate a control cycle for this signal (essentially, to suggest this signal once again to the M-controller 400b).

As a fourth example, if the FE-controller 400a initiates a control cycle with a signal that interferes with the current selected signals on the pin 321, the M-controller 400b may anticipate a potential handover. In such cases, the M-controller 400b may respond by accepting the new signal. In this case, the modem 320 may tolerate the interference of this signal (for some time). Alternatively or additionally, the modem 320 may apply time-division for these signals.

Other and additional information may be passed between the M-controller 400b and the FE-controller 400a. For example:
the M-controller 400b may request the FE-controller 400a for the number of signals (segments).
the M-controller 400b may request the FE-controller 400a for the actual strength of a signal;
the M-controller 400b may request for a status update on which the FE-controller 400a provides the actual signal strength for each signal; and/or
the M-controller 400b may request full control (e.g. the M-controller 400b may forbid or prevent the FE-controller 400a from initiating a control cycle).

A specific example relates to the EP 350 deciding to handover from a first AP 200a to a second AP 200b (see, for example, FIG. 4). In such cases the FE-controller 400a may have signals from both APs 200 added on the same pin 321 of the modem 320. The M-controller 400b may wish to remove one or more of these signals originating from the first AP 200a and to add previously rejected signals originating from the second AP 200b. In this case, the M-controller 400b may accordingly initiate one or multiple control cycles for that purpose.

As mentioned above, the receiver system of the example shown in FIG. 9 may be implemented at an AP 200. The discussion above in relation to FIG. 9 also applies in such implementations, except that there are potentially multiple EPs 350 in communication with the (AP) receiver system 300. Hence, the FE-controller 400a in these cases must know which EP 350 is actively transmitting at which time to activate the corresponding set of signals for that EP 350 and to analyse the incoming signals for that EP 350. Since the FE-controller 400a itself is not able to detect which EP 350 is sending, it depends for that on the information it receives from the M-controller 400b. That is, only the modem 320 can determine which EP 350 provided a particular signal. Hence, information related to this must be provided to the FE-controller 400a via the M-controller 400b.

In an example, the FE-controller 400a may apply a multi-tasking process with a different “task” for each EP 350 currently in communication with the receiver system 300.

Each task for an EP 350 contains the following actions:
1. Assessing the measured signals when the EP 350 is transmitting;
2. Selecting the appropriate signals for the pin 321 when the EP 350 is transmitting; and
3. Executing a control cycle for the EP350.

“3” can be implemented as a background process (and may also run when another EP is transmitting,) under the condition that such a cycle finishes within a predetermine period of time (e.g. 40 ms, 100 ms, etc.)

There are three potentially different situations for how the M-controller 400b may provide the information on which EP 350 is sending at which time for the above first two actions (“1” and “2”):
The modem 320 may apply a TDMA schedule determining which EP 350 shall send at which time. In this case the M-controller 400b provides this schedule to the FE-controller 400a for use in identifying the EP responsible for each signal.
The modem 320 may apply a polling mechanism whereby it determines which EP 350 shall send next at which time. This is less deterministic than a TDMA schedule but the access of the EPs to the medium is still under control of the AP 200. In this case the M-controller 400b may provide an indication of which EP 350 will transmit next and at which time it starts transmitting and optionally when it stops transmitting. This can be used by the FE-controller 400a to determine the EP responsible for the next signal.
The modem 320 may apply a MAC with contention access, whereby the EP 350 that wins the access starts transmitting. This means that the AP 200 has no control over the access of EPs to the medium. In this case, the M-controller 400b may provide an indication on which EP 350 is transmitting after receiving the header of the first frame from this EP 350. In addition, the M-controller 400b may provide an indication on the end of the preceding EP 350 transmission, which allows the FE-controller 400a to start assessing signal strengths of the yet unknown next EP 350 directly after the end of an EP transmission and then to link these measurements to the EP 350 as soon as its identifier is known.

In an example, the FE-controller 400a and M-controller 400b may initiate multiple control cycles (one for each EP 350) and execute them concurrently, whereby both keep track of the control cycle state for each EP 350. To address for which EP 350 a message in a control cycle is intended, a control message may carry an EP identifier in addition to the other information as explained before.

As mentioned above, the selection unit may provide multiple OWC signals (i.e. a combination thereof) to multiple pins of the modem simultaneously. This can be the case with both the EP-side and AP-side implementation, which will now be discussed in turn. It is appreciated that all aspects disclosed above apply, and that the description is given only insofar as required to be understood (e.g. aspects having corresponding features to already described may not be repeated in detail).

FIG. 11 shows schematically a first example in which the modem 320 is implemented at an EP. Hence, the modem 320 may be referred to as an EP-modem or simply “EP-M”.

In this example, the modem 320 has two input pins 321a, 321b. In this example, the switch arrangement 313 is implemented as two adders 313a, 313b. That is, the FE-controller 310 has two adders 313a, 313b. The first adder 313a is connected to the first pin 321a and the second adder is connected to the second pin 321b. It is appreciated that this example may be extended to a modem 320 having three or more pins 321. E.g. there may be a respect adder 313 for each input pin 321 of the modem 320.

Because the modem 320 has multiple (two in this example) signal interfaces (pins 321a, 321b), the modem 320 can have a first signal or a set of first signals selected for a first signal interface 321a of the modem 320 and a second signal or a set of second signals selected for a second signal interface 321b of the modem 320. This allows the modem 320 to analyse the signal(s) of each signal interface 321 separately. This concept can be extended for a third signal interface of the modem 320 and so on.

This is especially relevant for the situation that the EP can received signals from multiple APs. The M-controller may in cooperation with the FE-controller arrange to separate the signals of the APs by assigning them to different signal interfaces of the modem.

The control system 300 (FE-controller 400a and M-controller 400b) may also arrange to first examine a signal on a second signal interface before adding it onto a first signal interface 321a (or second signal interface 321b, etc.).

The control cycles as defined before may be reused.

An example process of finding an optimal set of signals for a stable positioned EP will now be described.
The M-controller 400b assigns a first signal interface to establish and maintain a link to an AP and a second signal interface to examine signals. For example, the M-controller 400b may determine to use the first pin 321a for establishing and maintaining the communication link, and the second pin 321b (or a different pin 321) for “probing” other signals. The M-controller 400b indicates to the FE-controller 400a, which signal interface 321 has which role, e.g. the first signal interface 321a for establishing and maintaining a link (link-interface) and a second signal interface 321b for examining signals (examine-interface).
Initially, the FE-controller 400a has no signal selected and indicates this state to the M-controller 400b by sending a message that no valid signal is available.
In this initial state, the FE-controller 400a monitors incoming signals and if at least one signal is viable, e.g. has a signal strength (or SNR, etc.) above a first threshold, it selects that signal and initiates a control cycle to add this signal to the examine-interface. If more than one signal is viable, then the FE-controller 400a may select the signal with the highest signal strength, SNR, etc. and initiates a control cycle to add this signal to examine-interface.
If the M-controller 400b accepts the signal, it instructs the FE-controller 400a to move the signal from the examine-interface to the link-interface. It may do so by an additional indication in the accept response or by initiating one or multiple appropriate control cycles.
The FE-controller 400a may continue the process of monitoring signals and sequentially letting the EP-M 320 examine each signal with strength above the first threshold on the examine-interface and the M-controller 400b may accept/reject.

A process of adapting the set of signals for changing situation will now be described.
If the situation of the EP changes, e.g. due a change of its position to an AP or to multiple APs, the FE-controller 400a may take additional actions.
If the strength of a signal that was previously below a threshold rises above a threshold, the FE-controller 400a initiates a control cycle for the examine-interface.
If the strength of a currently selected signal on the link-interface falls below a second threshold, the FE-controller 400a initiates a control cycle to remove this signal from the link-interface.
If the strength of a signal marked as rejected increases (and e.g. becomes larger than the currently selected signals), the FE-controller 400a re-initiates a control cycle for the examine-interface.
If the FE-controller 400a initiates a control cycle with a signal that would interfere with the current selected signals on link-interface, the M-controller 400b may anticipate on a potential handover and accordingly responds with an accept. In this case, the EP-M 320 will not indicate to move the signal to the link-interface, but to keep it at the examine-interface to prevent the interference. The M-controller 400b may even accept multiple signals to be added on the examine-interface for that purpose. This may result in the situation that the FE-controller 400a has one or multiple signals added on the link-interface related to the AP to which it is actually associated (AP1) and has one or multiple signals added on the examine-interface related to an AP that the EP regards as candidate for handover (AP2). If the EP decides to handover from AP1 to AP2, the M-controller 400b swaps the roles of both signal interfaces by sending a message that redefines the roles for them. (Alternatively, the M-controller 400b may swap the signals between the two signal interfaces.)

The above processes describe the situation for two signal interfaces. With three or more signal interfaces, it is possible to enhance the EP. For example, the M-controller 400b may assign a first signal interface 321a for a first link (with AP1), a second signal interface 321b for a candidate new link (with AP2) and a third signal interface 321c for examining signals. In this case, the EP may prepare for a handover thereby building up a good selection of signals for AP2 while maintaining a good connection with AP1 and still be able to examine to be added signals without interfering on the two first signal interfaces.

As another example, the EP may assign both a first as well as a second signal interface for a MIMO link with an AP, whereby the EP receives different information from the AP via the two signal interfaces. The EP may then examine other signals on the third signal interface and in case of acceptance decide to move the signal to the first or to the second signal interface. As mentioned, this can also be extended to more than 3 signal interfaces to handle more than two APs, more than two MIMO information streams or a combination of multiple APs and MIMO streams.

The receiver system 300 shown in FIG. 11 may also be implemented at an AP (the modem 320 may be referred to as an AP-modem or simply “AP-M”). In such cases, the M-controller 400b may assign a first signal interface 321a to establish and maintain a link to an EP and a second signal interface 321b to examine signals. The M-controller 400b may also indicate, to the FE-controller 400a, which signal interface 321 has which role, e.g. the first signal interface for establishing and maintaining a link (link-interface) and a second signal interface for examining signals (examine-interface).

A process performed by the AP for associating new EP (identifier is not yet established) was described above. In addition, the AP may select the input signals to be added for new EPs on the link-interface or on the examine-interface. Moreover, the AP may select different sets of signals to be added on the link-interface and on the examine-interface.

After association to a new EP, the FE-controller 400a may have no preference for selecting the signals for that EP and may therefore select all signals that are above a first threshold for the link-interface and indicates this state to the M-controller 400b by sending a message with the active signals. In this example, as the receiver system 300 is implemented at an AP (in contrast to the above-described in which the receiver system 300 was implemented at an EP), this message preferably contains an identifier for the EP and for each actively selected signal and signal identifier for the link-interface.

If the FE-controller 400a has more than one signal selected for the link-interface 321, it may try to improve by proposing to remove a signal. For that purpose, the FE-controller 400a may choose a signal from the currently selected and initiate a control cycle to remove that signal from the link-interface. Alternatively, the M-controller 400b may choose a signal and start a control cycle to remove that signal from the link-interface 321.

The FE-controller 400a may continue with the process until for all signals that are currently selected for the link-interface.

If the situation of the EP changes, e.g. due a change of its position to the EP or other EPs changing their position (change of interference), the FE-controller may take additional actions. For example:
If the strength of a signal that was previously below a threshold rises above a threshold, the FE-controller 400a initiates a control cycle to add this signal to the examine-interface.
If the strength of a currently selected signals falls below a second threshold, the FE-controller 400a initiates a control cycle to remove this signal from the link-interface.
If the strength of a signal previously marked as rejected, increases (and e.g. becomes larger than the currently selected signals), the FE-controller 400a may re-initiate a control cycle to add this signal to the examine-interface.

Similarly to the previous example, it is also possible that the adder 313 provides a single signal or more than two signals to the modem 320. The protocols as been described between FE-controller 400a and M-controller 400b for an AP with single OFE and multiple segments can be re-applied between FE-controller 400a and M-controller 400b for this example.

Finally, it is appreciated that the concepts described above relating to the passing of multiple OWC signals to one or more pins of the modem 320 may be combined in particular with the examples of FIGS. 6, 7 and 8.

It will be understood that the circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A receiver system for receiving optical wireless communication (OWC) signals from an access point device of an OWC network, the receiver system comprising:
a MIMO modem having at least a first input interface and a second input interface capable of demodulating signals received via the first input interface, via the second input interface or both when present;
a front end comprising: a plurality of photodetectors for receiving optical wireless communication (OWC) signals; and a switch arrangement for selectively passing electrical OWC signals from the photodetectors to the modem via the first input interface and the second input interfaces; and
a selection unit for controlling the switch arrangement;
wherein the modem is configured to:
assign, for each input interface, a respective recommendation, for use by the selection unit, to electrical OWC signals currently being passed by the switch arrangement to the modem via that input interface, and
provide said recommendations to the selection unit;
the selection unit is configured to select electrical OWC signals to be passed by the switch arrangement to the input interfaces of the modem based at least in part on the recommendations received from the modem,
control the switch arrangement in accordance with the selected electrical OWC signals; and
wherein the modem is configured to:
assign a keep recommendation for a first electrical OWC signal on the first input interface, to not deselect the first electrical OWC signal when the first electrical OWC signal is used to connect to an OWC network and assign a de-selectable recommendation to a second electrical OWC signal to the second input interface, that the modem is not currently using, and
wherein the selection unit is configured to:
keep the first electrical OWC signal on the first input interface selected and deselect the OWC signal having the de-selectable recommendation from being passed by the switch arrangement to the second of the input interfaces of the modem when said recommendations includes the keep recommendation for the first input interface and the de-selectable recommendation for the second input interface, and selectively pass another, not currently being passed, electrical OWC signal from the photodetectors to the modem, based on received signal strengths.

2. (canceled)

3. (canceled)

4. (canceled)

5. The receiver system according to claim 1, 4, wherein said recommendations include at least a preferably-keep recommendation, the selection unit configured to only deselect an OWC signal having the preferably-keep recommendation if a signal strength of that OWC signal falls below a threshold signal strength.

6. The receiver system according to claim 1, wherein said recommendations include at least a discard recommendation, and the selection unit of the front end is configured to not select an OWC signal having the discard recommendation.

7. The receiver system according to claim 1, wherein the recommendations are associated with a numerical value, and the selection unit is configured to select OWC signals to be passed by the switch arrangement based on one of maximising and minimising the sum of the numerical recommendations assigned by the modem.

8. The receiver system according to claim 1, wherein the front end comprises at least one signal strength detector for measuring signal strengths of OWC signals received via the photodetectors and providing the measured strengths to the selection unit, and wherein the selection unit is configured to select OWC signals to be passed by the switch arrangement based on the measured signal strengths and subject to the assigned recommendations.

9. The receiver system according to claim 1, wherein the modem is configured to demodulate the OWC signals received via each input interface and to assign said recommendations based on at least one property of the demodulated signals selected from: a signal to noise ratio, a bit-error rate, a sub-channel dependency, a signal to interference ratio, and a signal to noise and interference ratio.

10. The receiver system according to claim 1, wherein the selection unit is configured to search for a new OWC signal if none of the currently selected OWC signals is assigned a recommendation by the modem that indicates that the OWC signal is not to be deselected or is preferably to be kept, and to provide an indication of the new OWC signal to the modem, the modem being configured to analyse the new OWC signal next on receipt of the indication.

11. The receiver system according to claim 1, wherein the selection unit is configured to perform a new selection of which OWC signals to pass to the modem in response to an instruction received from the modem.

12. (canceled)

13. (canceled)

14. (canceled)

15. (canceled)
